(19) United States
(12) Patent Application Publication
(10) Pub. No.: US 2026/0340431 A1
(43) Pub. Date: Oct. 29, 2026

(54) PERFORMING COLLECTIVE OPERATIONS USING ELECTROMAGNETIC SIGNALS HAVING SPATIALLY DISTRIBUTED ENTRIES

(71) Applicant: Microsoft Technology Licensing, LLC, Redmond, WA (US)

(72) Inventor: Teresa A. NICK, Towson, MD (US)

(73) Assignee: Microsoft Technology Licensing, LLC, Redmond, WA (US)

(21) Appl. No.: 19/187,181

(22) Filed: Apr. 23, 2025

(51) Int. Cl. G06N 5/022

(52) U.S. Cl. CPC G06N 5/022

(57) ABSTRACT

A method of performing a collective operation using electromagnetic energy includes displaying a first encoded electromagnetic signal representing a first value encoded via a property of electromagnetic energy as a first pattern of one or more entries and displaying a second encoded electromagnetic signal representing a second value encoded via the property of electromagnetic energy as a second pattern of one or more entries. A first entry of the first pattern and a first entry of the second pattern are each displayed at a first shared entry window and are at least partially collocated. Based on detecting and counting the properties of electromagnetic energy at the first shared entry space, a count is determined for a first index position. The method includes determining a sum value of the first and second values based on the count and a multiplication factor for the first index position.

### BACKGROUND OF THE DISCLOSURE

Artificial intelligence (AI) is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short-Term Memory (LSTM) neural networks, or Gated Recurrent Units (GRUs) have been deployed to perform such complex tasks. In many such systems, parallelism is used to accelerate operations associated with the model. Parallel operations are utilized for processing information (e.g., inputs or embeddings) though the various layers of the model and loading memory to perform these operations can present significant bottlenecks, which ultimately degrades performances of artificial intelligence systems during both inference and training.

Accordingly, there is a need for systems and methods that reduce latencies in artificial intelligence models.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an example system environment 100 for performing collective operations associated with artificial intelligence (AI) using a property of electromagnetic energy, according to at least one embodiment of the present disclosure;

FIG. 2 illustrates an example set of signals that are communicated using electromagnetic energy to perform collective operations associate with AI, according to at least one embodiment of the present disclosure;

FIG. 3 illustrates a binary encoding scheme which may be used for encoding and displaying electromagnetic signals as part of a collective operation, according to at least one embodiment of the present disclosure;

FIGS. 4-1 and 4-2 illustrate various techniques for the formation of cumulative electromagnetic signals in accordance with the techniques described herein, according to at least one embodiment of the present disclosure;

FIG. 5-1 illustrates an example process for determining a sum value by scanning various shared entry windows, according to at least one embodiment of the present disclosure;

FIGS. 5-2 and 5-3 illustrate examples of regions of interest within a shared entry window, according to at least one embodiment of the present disclosure;

FIG. 6-1 illustrates an example of various nodes of a layer L−1 and various nodes of a layer L, and connections therebetween, according to at least one embodiment of the present disclosure;

FIG. 6-2 illustrates a cumulative electromagnetic signal representing various weighted activations in relation to the architecture of FIG. 6-1;

FIGS. 7-1 through 7-4 illustrate an example of a system performing a collective operation using electromagnetic signal, according to at least one embodiment of the present disclosure;

FIG. 8 illustrates a flow diagram for a method or a series of acts for performing a collective operation using electromagnetic energy, according to at least one embodiment of the present disclosure; and

FIG. 9 illustrates certain components that may be included within a computing system.

### DETAILED DESCRIPTION

The present disclosure relates to performing collective operations associated with a machine learning (ML) or artificial intelligence (AI) models using a property of electromagnetic energy. Collective operations include operations that allow collection of data from different nodes, neurons, or processing units for combining into a result for (the same or different) nodes, neurons, or processing units. For example, data from one or more processing units (e.g., GPUs) associated with one portion of the AI system may be combine into a result for another portion of the AI system. As an example, during inference, a layer of an AI model provides results of a computation by neurons in that layer to the neurons for the next layer. This means that all of the computations from a layer (e.g., layer L−1) would have to be supplied to each processing unit that would perform the next layer's (layer L) computations. As used herein the term “neuron” or “node” refers to a connection point or computational unit in an artificial intelligence system having layers for processing inputs and providing outputs, where the neuron has the capability to receive an input and provide an output to other connection points in the AI system.

Similarly, during training as part of backpropagation, model parameters are synchronized by exchanging updated gradients. Parameter updates are applied during backpropagation. Thus, during training as part of a backward pass a layer of an AI model provides results of the computation by neurons in that layer to the neurons for the previous layer. As an example, the gradient of a loss function with respect to the weights in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole.

In one example, using the systems and methods described herein, the summation of weighted activations can be processed as part of a collective operation by leveraging the display of electromagnetic signals which are encoded representations of the weighted activations. The summation is then transmitted to the next nodes and/or layer. In some cases, the summation of the weighted activations is transmitted to the next nodes and/or layer without transmitting the weighted activations themselves. In some instances, control planes may not be necessary because the processing units can either be pre-programmed to process a defined part of the model (inference) or self-organize and parallelize the model based on the size of their allotted data partition (training). Although transmission bandwidth as described herein may be limited by visible light peripherals, such as displays and image sensors operating based on visible light, that are optimized for relatively slow human vision, this limit does not present a technological barrier. For example, in some embodiments, peripherals for generating electromagnetic energy signals (e.g., displays) and for receiving or sensing electromagnetic energy signals (e.g., image or light sensors) may be implemented which may operate based on electromagnetic energy that is not in the visible spectrum and/or optimized for speeds above that which human vision can detect. For instance, electromagnetic energy from at least infrared rays to ultraviolet rays, including visible light, may be used with the systems and methods described herein. In terms of wavelength, the electromagnetic energy may range from nanometers (e.g., 400 nanometers) to a few microns (e.g., 1.6 microns). The specific range of wavelength that is used will depend on the type of displays, sensors, or other such equipment being used for the communication of the electromagnetic energy. As an example, radiofrequency waves in a range of 3 kHz to 300 MHz may be used. As another example, microwaves in a range of 300 MHz to 300 GHz may also be used. Depending on the frequency, and thus the wavelength, of the electromagnetic energy being used, the equipment used for communicating such signals may be tailored.

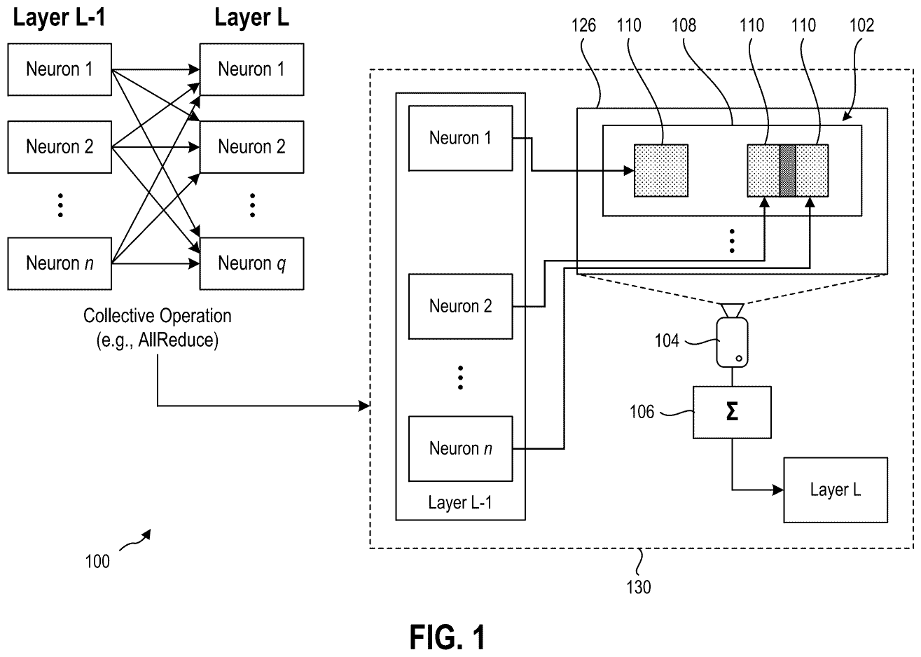

FIG. 1 illustrates an example system environment 100 for performing collective operations associated with artificial intelligence (AI) using a property of electromagnetic energy, according to at least one embodiment of the present disclosure. In some cases, system environment 100 relates to an AI system that, once trained, can be used for predicting outputs as part of inference. System environment 100 shows the model as including layers L−1 and L, where layer L−1 includes several neurons (neuron 1, neuron 2, up to neuron N) and layer L includes several neurons (neuron 1, neuron 2, up to neuron Q). For neuron 1 in layer L, the activation is equal to an activation function (Ø) on the sum of all weighted inputs or weighted activations (aw) to neuron 1 with some bias b:

$${a}_{1}^{( l )} = ∅ ( {a}_{1}^{( l - 1 )} {w}_{1 , 1}^{( l )} + {a}_{2}^{( l - 1 )} {w}_{2 , 1}^{( l )} + … + {a}_{n}^{( l - 1 )} {w}_{n , 1}^{( l )} + {b}^{( l )} ) .$$

The inputs

$$( e . g . , {a}_{1}^{( l - 1 )} , {a}_{2}^{( l - 1 )} , and {a}_{n}^{( l - 1 )} )$$

in this example are the set of values for which one needs to predict an output value. These can be viewed as features or attributes included in the data. The weights

$$( e . g . , {w}_{1 , 1}^{( l )} , {w}_{2 , 1}^{( l )} , and {w}_{n , 1}^{( l )} )$$

are values that are attached to each input to convey the importance of the corresponding input or feature in predicting the final output. The bias (e.g., b^{(l)}) can be used to shift the activation function towards left or right. The weights and the bias are parameters that have been learned during training of the AI model.

The activation function (e.g., Ø) is used to introduce non-linearity in the model and the summation function is used to bind the weights and inputs together. Examples of activation functions include rectified linear unit (ReLU) activation function, leaky ReLU, parametric ReLU, Gaussian-error linear unit (GELU) activation function, and other variants of ReLU. Moreover, aside from ReLU any other appropriate non-linear or linear activation functions may be used. In this example, in order to calculate the summation for a node of layer L (e.g.,

$${a}_{1}^{( l )}$$

for neuron 1), one needs information across all of layer L−1, even if the neurons in layer L−1 are partitioned across processing units as part of parallelism. This means that in this example all of the layer L−1 activations would have to be supplied to each processing unit that would calculate layers L's

$${a}_{1}^{( l )} to {a}_{q}^{( l )} .$$

In some conventional solutions, in order to communicate the data (e.g., activations) from the nodes of layer L−1 to layer L (e.g., between processing units operating these various nodes and/or layers), the data is transmitted through the neural network by traditional electronic means. For example, after computing the activations for its own nodes, the layer L−1 must serialize and transmit the data to the layer L, where they must be stored in memory or storage. Additionally, to process the activation function and compute the activations for the nodes of layer L, the layer L (e.g., one or more processing units) must recall each of the relevant activations from layer L−1, and compute the activation function on those activations (e.g., including applying corresponding weights to the activations) in order to produce sum values representing the activations for the nodes for layer L.

The flow of information across the neural network and the operation of the AI model as a whole in this way can typically be very memory and computation expensive. For example, it is not uncommon for modern AI models to have trillions of parameters (e.g., nodes), resulting in millions or even billions of computations (e.g., activation functions) to perform at each layer. While GPUs are typically leveraged for their ability to perform large amounts of parallel operations efficiently, even still, the sheer volume of computations to be performed can present a considerable bottleneck to the operation of an AI model. Indeed, in addition to the actual computing of the activation functions, this large volume of data has to be serialized and transmitted to the next layer of the model, which at the scale of millions or billions of activations per layer, can result in significant latency issues.

The delay associated with this computation aspect of AI models is even further exacerbated by bottlenecks associated with memory functions. For example, even given that GPUs may be particularly suited for performing a large number of computations, fetching, and storing data from memory can introduce even more significant latency issues. For instance, moving data between GPUs (or other processing units) and VRAM (or other memory) is often orders of magnitude slower than the computations themselves. Indeed, a considerable amount of the bottleneck/latency issues with AI models is often attributable to the delay in memory access functions. Moreover, AI models require a significant amount of memory resources to store weights, activations, and other data. As memory hardware resources are typically limited, and the volume of data utilized by AI models is continually growing, data overflows spill to slower memory or other storage devices, causing further delays.

The techniques of the present disclosure facilitate performing collective operations or computations (e.g., summing weighted activations) at a layer of an AI model, as well as consolidating the data to be transmitted between layers, to reduce or mitigate latency issues associated with AI models. For example, by displaying the weighted activations as encoded electromagnetic signals, and bitwise summing the weighted activations with an image sensor detecting the electromagnetic signals, the data that is typically transmitted between layers (e.g., each of the weighted activations) can effectively be consolidated to a single sum value (e.g., a single sum value for each receiving node) providing significant savings associated with transmission bandwidth, serialization, memory access, and other functionalities. Indeed, in many cases, a layer (e.g., layer L) may process activation functions and determine activations for its nodes without actually having received the underlying activations from the previous layer (e.g., layer L−1), but rather based on receiving a (e.g., single) sum value for each receiving node. In this way, the collective operations via displayed electromagnetic signals as described herein may facilitate a more efficient operation of AI models by consolidating and streamlining the transmission of data between layers.

As used herein, an “activation,” “activation value,” or the like may refer to any input value which is received, determined, or which applies specifically to a node of an AI model. For example, an activation may be any value (e.g., number) which is generated and/or received by any portion of an AI model and may not be limited to only being activation values, for instance, as part of an inferencing operation of an AI model. Also, as used herein, “weight,” “weight value,” or the like may refer to any learned parameter by an AI model. For example, a weight may be any parameter (e.g., number) which is static, known, or learned and which corresponds to an input value for adjusting, modifying, or otherwise weighing the input value. Accordingly, a weighted activation may be any value or input which is multiplied, weighted, adjusted, or modified by a learned parameter (e.g., a weight), such as are processed by neurons of an AI model.

The system environment 100 shows system 130, which is one example implementation for performing the collective operation as part of the AI system. System 130 may include one or more processing units for implementing, hosting, or operating the various nodes or neurons of the model. Each of the processing units can be a graphics processing unit (GPU), or may be implemented using other hardware options, as well, such as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices.

In some embodiments, a processing unit may be configured to process one or more neurons associated with a layer. As an example, assuming there are 256 neurons in layer L, the 256 neurons may be hosted or processed by one, or multiple processing units. Partitioning may be performed using code configured to partition the model based on machine language frameworks, such as Tensorflow, Apache MXNet, and Microsoft© Cognitive Toolkit (CNTK). Thus, the various layers of the model may be assigned for processing using different processing units. This way the various parameters associated with layers may be processed in parallel.

In one example, the neural network model may comprise many layers and each layer may be encoded as matrices or vectors of weights expressed in the form of coefficients or constants that have been obtained via training of a neural network. Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An LSTM layer may be described using a set of equations, such as the ones below:

iₜ=σ(Wₓᵢxt+Wₕᵢhₜ₋₁+W_{ci}cₜ₋₁+bᵢ)

fₜ=σ(W_{xf}xₜ+W_{hf}hₜ₋₁+W_{cf}cₜ₋₁+b_{f})

cₜ=fₜcₜ₋₁iₜ tan h(W_{xc}xₜ+W_{hc}hₜ₋₁+b_{c})

oₜ=σ(Wₓₒxt+Wₕₒhₜ₋₁+W_{co}cₜ+bₒ)

hₜ=oₜ tan h(cₜ)

In this example, inside each LSTM layer the inputs and hidden states may be processed using a combination of vector operations (e.g., dot-product, inner product, or vector addition) and non-linear functions. In certain cases, the most compute intensive operations may arise from the dot products, which may be implemented using dense matrix-vector and matrix-matrix multiplication routines. Although FIG. 1 shows system 130 as including certain components that are arranged in a certain manner, system 130 may include additional or fewer components arranged differently.

System 130 and the associated models can be deployed in cloud computing environments. Cloud computing may refer to a way for enabling on-demand network access to a shared pool of configurable processing units. For example, cloud computing can be employed in the marketplace to offer ubiquitous and convenient on-demand access to the shared pool of configurable processing units. The shared pool of configurable processing units can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

As mentioned, the various neurons 1-N for layer L−1 may have weighted activations for summing and transmitting to the various nodes of Layer L. The neurons of layer L−1 may each present or display an encoded electromagnetic signal representative of their weighted activation(s). For example, one or more processing units may be coupled to display devices for displaying the electromagnetic signals 102 on a display 126, screens, or other space. In one example, the display devices include projector displays for projecting onto the display 126, such as a screen. In other examples, the display devices include emitter displays (LED display, LCD display, or other device having emitters and/or pixels for presenting information) having one or more emitters for displaying electromagnetic signals on the display 126 via the emitters. The display 126 and display devices may be implemented via display links such as display port links, peripheral component interconnect express (PCIe) links, HDMI links, or other high-speed links. In this way, the electromagnetic signals 102 for various neurons are displayed at a common display 12, such as a shared space or meta space, in order that the electromagnetic signals 102 may be counted, combined, and/or summed to generate a sum value 106.

The electromagnetic signals 102 may be encoded electromagnetic signals which may comprise a pattern, shape, array, matrix, or other form, encoded for presenting a value (e.g., a decimal number of a weighted activation) via a property of electromagnetic energy. For instance, as described below in greater detail, in some cases the electromagnetic signals 102 are a pattern of entries (e.g., pixels, regions, or other discrete locations representing bits) each having a selected light intensity or brightness to represent a bit of a bit pattern encoding the underlying value. Thus, by observing or detecting various light intensity for entries at certain shared entry windows 108 corresponding to indexed locations of the entries of the associated encoding scheme, the various bits may be identified and the underlying value determined. In some cases, some of the electromagnetic signals 102 may overlap (e.g., some of the entries 110 may overlap). Accordingly, the weighted activations for each neuron of layer L−1 can be displayed via encoded electromagnetic signals 102.

The system 130 includes an image sensor 104 which may observe the display 126 and may detect the displayed electromagnetic signals 102. For instance, the image sensor 104 may be one or more of a camera, light sensor, photodetector, or other image sensor. The image sensor 104 may detect the displayed electromagnetic signals 102 and may determine a sum (e.g., sum value 106) of the underlying values (e.g., weighted activations) for transmitting to the layer L. For instance, the image sensor 104 may include a processor (e.g., FPGA) which may operate in-line with the image sensor 104 to perform the collective operation as described herein for transmitting the sum value 106 to the layer L. In some cases, the image sensor 104 may be operated by or otherwise associated with one or more processors which host or implement the various nodes, such as a processor associated with Layer L−1 or with Layer L.

The image sensor 104 may determine the sum value 106 based on observing various shared entry windows 108 of the electromagnetic signals 102 and determining a count for various index positions corresponding with the encoding of the electromagnetic signals 102. For example, the image sensor 104 may observe, at each shared entry window 108, a single entry 110 of each of the electromagnetic signals 102 and may determine an overall count (e.g., across the shared entry window) for that index position to utilize in determining the sum value 106. Based on determining a count, entry by entry, for each index position, and utilizing a multiplication factor for each index position, the image sensor 104 (e.g., the associated processor) can estimate, approximate, or determine the sum value 106. More details regarding the shared entry windows and the entry-wise summation of the electromagnetic signals to determine the sum value 106 is described below in connection with FIGS. 4-1 through 6-2.

This technique of determining the sum value 106 via discrete entries and shared entry windows may be in contrast to, for example, simply detecting each electromagnetic signal (e.g., as a whole), identifying the underlying value, and summing the values in a typical computer computation. Rather, by detecting, entry-wise, the light intensity at each shared entry window to determine a count for each index position, large scale summation can be achieved without loading and recalling numerous weighted activation values from memory and performing a typical summation computation with a processor. Indeed, the system 130 may advantageously transmit just the sum value 106 (e.g., and sum values for all connections between nodes of the layer), rather than transmitting each of the weighted activations to the layer L to be summed at the layer L. In this way, bottlenecks typically associated with both transmitting data within a neural network, as well as memory access latencies, may be reduced or mitigated for providing improvements to the operation of AI models.

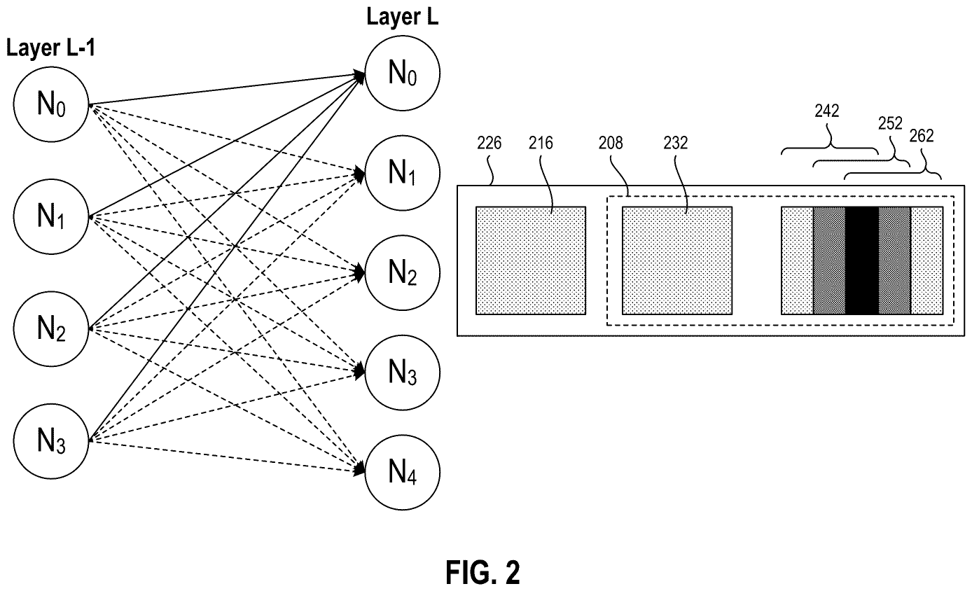

FIG. 2 shows an example set of signals that are communicated using electromagnetic energy to perform collective operations associated with artificial intelligence, according to at least one embodiment of the present disclosure. To explain the signals, four neurons N0, N1, N2, and N3 are shown for layer L−1 and five neurons N0, N1, N2, N3, and N4 are shown for layer L. This example relates to inference and shows the use of the electromagnetic energy in the context of signals being communicated from each of the four nodes NO, N1, N2, and N3 of layer L−1 to neurons of layer L. Accordingly, the weights (w) and bias (b) are known and can simply be stored local to the processing unit corresponding to the neurons. Thus, in this example, only the new input data to be processed by the neurons in layer L needs to be sent from each of the neurons of layer L−1 to neuron N0 of layer L. Neuron N0 of layer L needs to compute

$${a}_{0}^{( l )} = ∅ ( {a}_{0}^{( l - 1 )} {w}_{0 , 0}^{( l )} + {a}_{1}^{( l - 1 )} {w}_{1 , 0}^{( l )} + {a}_{2}^{( l - 1 )} {w}_{2 , 0}^{( l )} + {a}_{3}^{( l - 1 )} {w}_{3 , 0}^{( l )} + {b}^{( l )} ) .$$

To enable this computation, neuron N0 of layer L−1 needs to send the value of

$${a}_{0}^{( l - 1 )} {w}_{0 , 0}^{( l )}$$

to neuron N0 of layer L. Neuron N1 of layer L−1 needs to send the value of

$${a}_{1}^{( l - 1 )} {w}_{1 , 0}^{( l )}$$

to neuron N0 of layer L. Neuron N2 of layer L−1 needs to send the value of

$${a}_{2}^{( l - 1 )} {w}_{2 , 0}^{( l )}$$

to neuron N0 of layer L. Neuron N3 of layer L−1 needs to send the value of

$${a}_{3}^{( l - 1 )} {w}_{3 , 0}^{( l )}$$

to neuron N0 of layer L. Neurons N0-N5 of layer L need to communicate the activation sum signals to the next layer of the model.

In this example, the luminous intensity (e.g., brightness) of the electromagnetic energy (or other property of electromagnetic energy) is used to communicate data from each of the neurons (NO, N1, N2, and N3 of layer L−1) to the neurons associated with the next layer (layer L). Display 226 is representative of one or multiple displays which may display electromagnetic signals as described herein. Display 226 shows light shapes or patterns to illustrate example signals communicated by a processing unit.

On the display 226 are presented various encoded electromagnetic signals. For example, an encoded electromagnetic signal may be displayed corresponding with each of the nodes N0-N3 of layer L−1, including electromagnetic signals 232, 242, 252, and 262. The electromagnetic signals 232, 242, 252, and 262 are illustrated in FIG. 2 with respect to a single entry (e.g., of many entries of a pattern) of each electromagnetic signal, for example, for representing a single bit of an underlying encoding scheme. The entries are displayed at a shared entry window 208 which corresponds to an index position of the bit of the encoding scheme. It should be understood that in some embodiments, and in many cases, the electromagnetic signals 232, 242, 252, and 262 may each include multiple entries displayed at multiple shared entry windows 208 for representing multiple bits of an encoding scheme.

The encoded electromagnetic signals may provide information in this way for use with the neurons in the next layer. For instance, each of the nodes associated with layer L−1 displays one or more encoded electromagnetic signals at specific spots on the display 226, comprising a pattern which encodes, via light intensity (or other property), one or more of the weighted activations for that neuron and for communicating to one or more corresponding neurons of the layer L. For instance, in some cases, each node displays several electromagnetic signals which may encode (e.g., via several displayed shapes or patterns) multiple weighted activations for a connection of that neuron with one or more neurons of the layer L. As an example, electromagnetic signal 232 may correspond with node NO of layer L−1. Electromagnetic signal 232 may be displayed at a specific spot and may include an encoded pattern (e.g., a sequence of one or more entries) for a weighted activation

$${a}_{0}^{( l - 1 )} {w}_{0 , 0}^{( l )}$$

for communicating (e.g., after summing with other associated weighted activations) to node NO of layer L. In some cases node NO of layer l−1 displays several other electromagnetic signals in a similar manner for representing weighted activations

$${a}_{0}^{( l - 1 )} {w}_{0 , 1}^{( l )} , {a}_{0}^{( l - 1 )} {w}_{0 , 2}^{( l )} , {a}_{0}^{( l - 1 )} {w}_{0 , 3}^{( l )} , and {a}_{0}^{( l - 1 )} {w}_{0 , 4}^{( l )}$$

for communicating (e.g., after summing with other associated weighted activations) to the respective nodes of the layer L. Electromagnetic signal 242 may correspond with node N1 of layer L−1. Electromagnetic signal 242 may be displayed at a specific spot and may include an encoded pattern (e.g., a sequence of one or more entries) for a weighted activation

$${a}_{1}^{( l - 1 )} {w}_{1 , 0}^{( l )}$$

for communicating (e.g., after summing with other associated weighted activations) to node NO of layer L. In some cases, node N1 of layer L−1 displays several other electromagnetic signals in a similar manner for representing weighted activations

$${a}_{1}^{( l - 1 )} {w}_{1 , 1}^{( l )} , {a}_{1}^{( l - 1 )} {w}_{1 , 2}^{( l )} , {a}_{1}^{( l - 1 )} {w}_{1 , 3}^{( l )} , and {a}_{1}^{( l - 1 )} {w}_{1 , 4}^{( l )}$$

for communicating (e.g., after summing with other associated weighted activations) to the respective nodes of layer L. Electromagnetic signal 252 may correspond with node N2 of layer L−1. Electromagnetic signal 252 may be displayed at a specific spot and may include an encoded pattern (e.g., a sequence of one or more entries) for a weighted activation

$${a}_{2}^{( l - 1 )} {w}_{2 , 0}^{( l )}$$

for communicating (e.g., after summing with other associated weighted activations) to node NO of layer L. In some case, node N2 of layer L−1 displays several other electromagnetic signals in a similar manner for representing weighted activations

$${a}_{2}^{( l - 1 )} {w}_{2 , 1}^{( l )} , {a}_{2}^{( l - 1 )} {w}_{2 , 2}^{( l )} , {a}_{2}^{( l - 1 )} {w}_{2 , 3}^{( l )} and {a}_{2}^{( l - 1 )} {w}_{2 , 4}^{( l )}$$

for communicating (e.g., after summing with other associated weighted activations) to the respective nodes of layer L. Electromagnetic signal 262 may correspond with node N3 of layer L−1. Electromagnetic signal 262 may be displayed at a specific spot and may include an encoded pattern (e.g., a sequence of one or more entries) for a weighted activation

$${a}_{3}^{( l - 1 )} {w}_{3 , 0}^{( l )}$$

for communicating (e.g., after summing with other associated weighted activations) to node NO of layer L. In some cases, node N3 of Layer L−1 displays several other electromagnetic signals in a similar manner for representing weighted activations

$${a}_{3}^{( l - 1 )} {w}_{3 , 1}^{( l )} , {a}_{3}^{( l - 1 )} {w}_{3 , 2}^{( l )} , {a}_{3}^{( l - 1 )} {w}_{3 , 3}^{( l )} , and {a}_{3}^{( l - 1 )} {w}_{3 , 4}^{( l )}$$

for communicating (e.g., after summing with other associated weighted activations) to the respective nodes of layer L.

As described below in more detail, one or more image sensors (e.g., cameras) may observe or view the electromagnetic signals on the display 226, and in particular, may observe portions or individual entries of the electromagnetic signals by scanning or cycling through various shared entry windows. For instance, by viewing, entry-wise, the electromagnetic signals, the detected light intensity can be aggregated, counted, or summed at the shared entry windows corresponding with specific index positions of the encoding scheme of the electromagnetic signals. In this way, a total count can be summed for each given index position of the encoding scheme in order to estimate, infer, or approximate the sum of the underlying weighted activations (e.g., the sum of all weighted activations for a given receiving node). For instance, such an operation may result in the completion of the collective operation (e.g., AllReduce) such that the sum values for the weighted activations may be transmitted to respective receiving neurons of the layer L rather than transmitting each of the underlying weighted activations, improving bandwidth and bottleneck issues.

Although FIG. 2 shows a certain number and arrangement of neurons for the layers, each layer may include additional or fewer neurons. Moreover, the neurons for different layers can be supported by the same processing unit or different processing units. In addition, although FIG. 2 shows display 226 with a certain arrangement and type of signals, display 226 may include additional or fewer signals that are arranged differently. Display 226 itself may be several displays or display devices, or any other device or structure that can be used for the presenting of the luminous intensity (or other electromagnetic properties) associated with the electromagnetic energy. For instance, in some cases, each neuron may be associated with a separate display device (e.g., separate projector or set of emitters), or each processor (e.g., hosting several neurons) may have its own display.

In some cases, other types of signals may be displayed on one or more displays. For example, one or more reference signals 216 may be displayed which may facilitate counting or tallying the electromagnetic property of the various entries at a given shared entry window 208. For instance, the reference signal 216 may identify a base or reference light intensity for determining an on/off, 1/0, active/inactive, etc., state of the various entries of an electromagnetic signal. In some cases, one or more additional signals may be display for facilitating identifying a sending node or a receiving node. In some cases, one or more signals may be displayed for indicating which nodes have reported or participated in the collective operation. In some cases, one or more signals may be displayed which may facilitate synchronizing the display of electromagnetic signals across one or more displays, nodes, processors, etc.

In addition, although FIG. 2 shows the movement of data from layer L−1 to L, the movement of data may be in the opposite direction, as well. As noted earlier, during training as part of backpropagation, model parameters are updated by backflow of error gradients. Weight and bias parameter updates are applied during backpropagation. Thus, during training as part of a backward pass a layer of an AI model provides results of the loss or error computation by neurons in that layer to the neurons for the previous layer (e.g., neurons in layer L provides the results to the neurons in layer L−1 of FIG. 2). The gradient of a loss function with respect to the weights and bias in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole. As used herein, the term “electromagnetic signal” described earlier refers to gradient of the error in the context of backpropagation while training the AI model. Conversely, in the context of inference the “electromagnetic signal” refers to a displayed signal of a weighted activation.

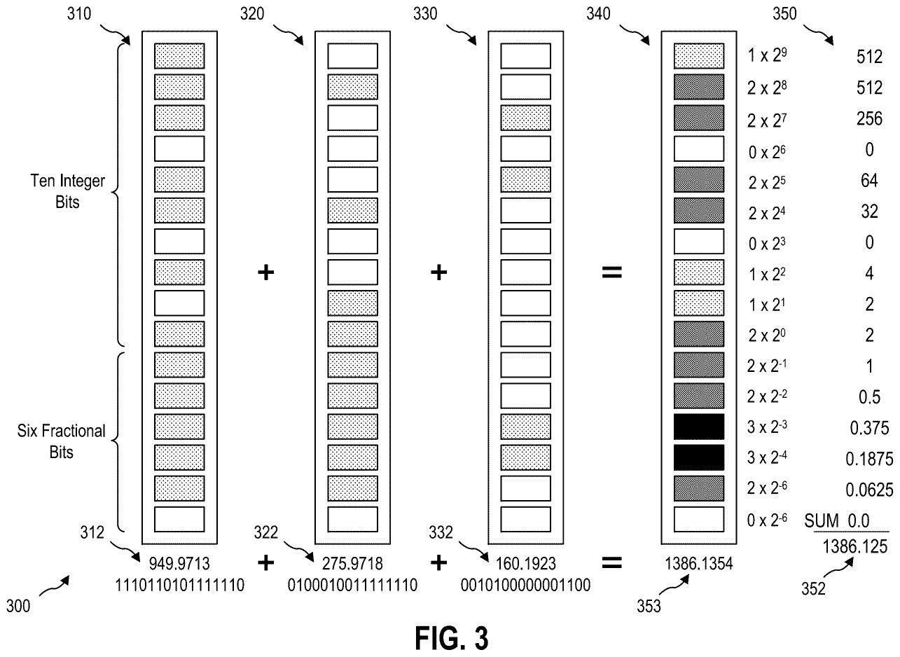

FIG. 3 shows a binary encoding scheme 300 which may be used for encoding and displaying electromagnetic signals as part of a collective operation, according to at least one embodiment of the present disclosure. In one example, electromagnetic signals may be represented as a pattern of entries, such as regions, pixels, or other bit-identifying areas, having varying light intensity for conveying bit values for a series of bits in a fixed-point binary representation for an underlying decimal value. Although floating point representation of values as part of the model processing may have slightly higher accuracy, this comes at the expense of transmission bandwidth. Accuracy and bandwidth can be optimized for each use case. To simplify the processing while maintaining a reasonable dynamic range of the values, fixed point representation of values may be used. In one example, fixed point representation may use a set number of integer bits and fractional bits to express numbers. Fixed point values can be efficiently processed in hardware with integer arithmetic, which may make it a preferred format for use with the systems described herein. Fixed point format may be represented as X.Y, where X is the number of integer bits and Y is the number of fractional bits. Block-floating point (BFP) may apply a shared exponent to a block of fixed-point numbers; for example, a vector or matrix. The shared exponent may allow a significantly higher dynamic range for the block, although individual block members have a fixed range with respect to each other. Quantization involving mapping continuous or high-precision values onto a discrete, low-precision grid, may be used to arrive at the fixed-point representations of the floating-point values. If the original points are close to their mapped quantization value, then one expects that the resulting computations will be close to the original computations.

As part of the binary encoding scheme 300 the electromagnetic signals (e.g., similar to 232, 242, 252, and 262 of FIG. 2) may be encoded using fixed-point integer values. For example, a first value 312 may be encoded as a first electromagnetic signal 310. The first value 312 may be a weighted activation for a connection between a first node and a target node. A second value 322 may be encoded as a second electromagnetic signal 320. The second value 322 may be a weighted activation for a connection between a second node and the target node. A third value 332 may be encoded as a third electromagnetic signal 330. The third value 332 may be a weighted activation for a connection between a third node and the target node. In the example shown in FIG. 3, the fixed-point integer values include ten integer bits and six fractional bits.

While the electromagnetic signals 310, 320, 330 are shown as columns, any shape, pattern, or form having various entries may be utilized for conveying the underlying values 312, 322, 332 based on specific indexed locations of the bits. For instance, FIG. 3 may be merely illustrative of the encoding scheme, and the electromagnetic signals may not necessarily present or be displayed as shown. For instance, as described herein, each entry of an electromagnetic signal may be displayed at a varied or spatially distributed location within a corresponding shared entry window such that the electromagnetic signal may not necessarily form a straight or uniform column. In some cases, the electromagnetic signals may be displayed or arranged as rows, or as another pattern, array, or form of various entries. Additionally, while each of the electromagnetic signals 310, 320, 330 is shown as conveying or representing a single value, in some cases the term “electromagnetic signal” as used herein may refer to a larger pattern or collection of (e.g., multiple columns of) entries which may convey multiple underlying values. More details related to the form and makeup of electromagnetic signals is described below in connection with FIGS. 4-1 and 4-2.

Accordingly, the relative positioning of the entries within each electromagnetic signal may correspond with various index positions of the associated encoding scheme. For instance, the encoding scheme may define a specific number of integer bits and fractional bits, and the index position may indicate which digit or position in the binary representation of the value each bit corresponds to (e.g., 10^{th} integer bit, 9^{th} integer bit, 1^{st} fractional bit, etc.). As shown adjacent column 340, the index position may correspond with a multiplication factor, which in some cases may be based on a binary encoding scheme. For instance, the multiplication factor may be a binary exponential multiplication factor. As an example, the index position of the tenth integer bit may correspond to a multiplication factor of 2⁹, an index position of the 9^{th} integer bit may correspond to a multiplication factor of 2⁸, and so on.

In this way, the underlying values may be represented in binary form by the electromagnetic signals. For example, at each entry of the electromagnetic signal, a light intensity may be varied to represent, in binary form, a 1 or a 0. For instance, the light intensity may be on or off, high or low, or other binary variation, and combinations thereof. Accordingly, by detecting the light intensity at each entry, a bit value of that digit (e.g., 1 or 0) may be inferred in order to determine the underlying value. For instance, as shown in columns 310-330, the light grey scale may correspond with a high light intensity (e.g., 1) and the white entries may correspond with a low light intensity (e.g., 0). In some cases, other properties of electromagnetic energy may be utilized, such as a color or wavelength to indicate a binary representation as described. Indeed, while the present techniques are generally described herein with reference to a property of electromagnetic energy being a light intensity or brightness, it should be understood that the techniques described herein may be applicable to the use of color or wavelength as a distinguishing electromagnetic property for use in encoding electromagnetic signals. Also, while the encoding scheme has been described primarily as a binary scheme, additional, or other (e.g., higher order) encoding schemes may be used. For example, a base 3, base 4, or higher order encoding scheme may be utilized, such as by utilizing 2, 3, or more light intensity values, colors, or a combination thereof, for each entry. Further, in some cases negative values may be represented by one or more light intensities and/or colors. Thus, the use of the term “bit” is not intended to be limiting to only binary or base 2 encoding schemes, but rather, is used to refer to a fundamental or smallest unit of information corresponding with any encoding scheme utilized in combination with the present techniques, including higher-order encoding schemes.

As shown in column 340, the entry-wise addition of the columns 310-330 may be achieved based on the natural additive or cumulative properties of the electromagnetic property through which the signals are encoded. For example, column 340 may represent a cumulative electromagnetic signal (e.g., having cumulative properties of electromagnetic energy) created or resulting from an overlaying, overlapping, or collocating of the columns 310-330 such that the electromagnetic properties of the various entries add or sum for the index positions. To elaborate, signals, or portions of signals, may be considered as collocated or overlapping when the signals are presented or displayed at a same space on a display, such as projected onto a common area or presented via sets of emitters (e.g., pixels) that are positioned adjacent and/or in close proximity. For instance, as shown by the differences in the intensity of gray shading in column 340, the information for the collective operation is communicated using the electromagnetic energy. In at least one embodiment an image sensor may be configured to detect various discrete light intensities such that a value, count, or tally for each index position can be determined. For instance, in some cases an image sensor may be configured to distinguish between 4, 8, 12, 16, or more discrete light intensities (or discrete values of another electromagnetic property) in order that the electromagnetic signals may be utilized to sum naturally through collocation.

As shown next to column 340, a count can be determined for each index position for summing the electromagnetic signals 310-330 (e.g., for summing the values 312, 322, 332). For instance, by determining the count of the cumulative light intensities at each index position, a count can be determined for the associated index position. For instance, for the 10^{th} integer index position, the count is 1, for the 9^{th} integer index position the count is 2, and so on based on the cumulative identified light intensity at the respective index location, as a combination of the light intensities of the underlying entries of each of electromagnetic signal 310, 320, 330. Based on the count and the multiplication factor, column 350 shows a computation to generate a sum value 352. In some cases, the sum value 352 may be an estimate or approximation of the mathematical sum or true sum 353 of the values 312, 322, 332. For example, the sum value 352 may include an error when summing up the binary numbers. The sum value 352 may be representative of the sum of the weighted activations for one target neuron. For instance, any number of weighted activations may be generated and may be displayed for summing together to generate the sum value 352.

In some cases, other mathematical calculations may be performed. For instance, an average or mean may be determined based on dividing the sum value 352 by the total number of electromagnetic signals. For instance, the sum value 352 may be representative of any value that is ultimately determined or calculated, and then transmitted to another node or layer. In other example, other statistical values can be determined.

In this way, the binary encoding scheme 300 may be utilized to facilitate the summing of two or more electromagnetic signals based on overlaying or collocating two or more electromagnetic signals. For instance, two or more electromagnetic signals may be projected onto a same space, or sets of emitters for displaying each electromagnetic signal may be located in close proximity such that the output of the emitters combines to a cumulative output. More information regarding this cumulative effect of collocated electromagnetic signals is described in U.S. patent application Ser. No. 18/526,186 filed Dec. 1, 2023, and Ser. No. 18/737,539 filed Jun. 7, 2024, which are hereby incorporated by reference in their entireties.

In some cases, this encoding scheme for electromagnetic signals may be implemented in combination with electromagnetic signals that are not collocated, or that are located at discrete or separate locations. For example, a set of weighted activations to be summed may be represented by electromagnetic signals that are discretely located, and the image sensor may scan through sets of regions of interest in order to determine, entry-wise, a total sum for the underlying weighted activations based on summing or tallying the entries as it progresses. In this way, the encoding scheme may be useful for encoding weighted input values as electromagnetic signals for display in any manner. Indeed, as described in further detail below, in some cases various electromagnetic signals may be displayed such that various entries are collocated or overlapping, various entries are discretely located or not overlapping, and also such that various entries are partially collocated or partially overlapping.

FIGS. 4-1 and 4-2 illustrate various techniques for the formation of cumulative electromagnetic signals in accordance with the techniques described herein, according to at least one embodiment. As mentioned above, in some cases electromagnetic signals may be encoded as shown and described in connection with FIG. 3, but may not necessarily be organized or arranged in straight or uniform columns. For example, while the various entries 410 of an electromagnetic signal may be encoded via an electromagnetic property (e.g., light intensity), the entries 410 may be displayed at spatially distributed locations within a shared entry window 408.

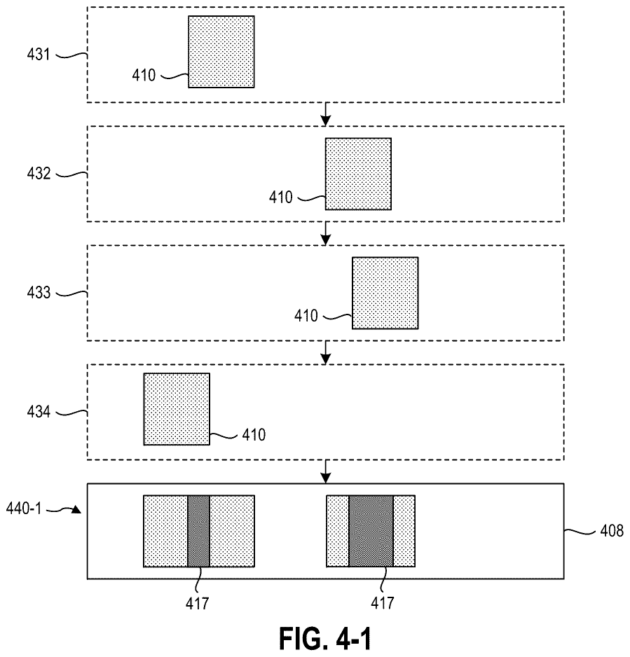

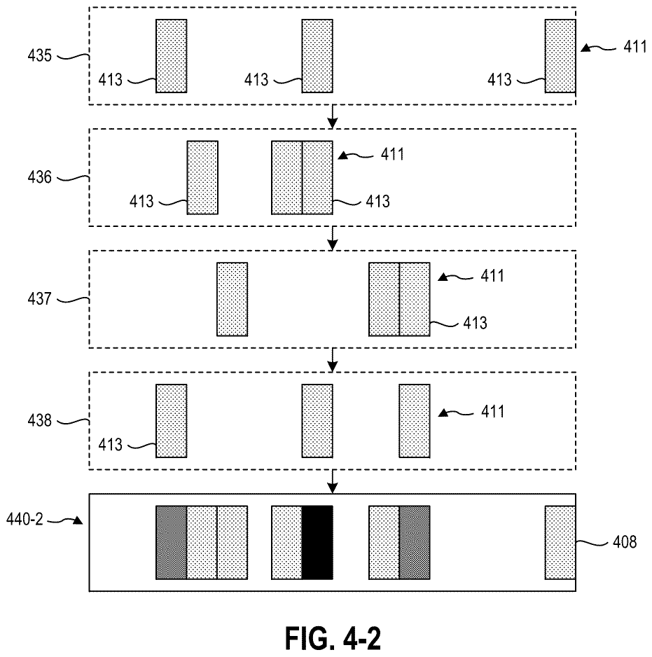

FIG. 4-1 shows a cumulative electromagnetic signal 440-1 which results from the display of four underlying electromagnetic signals 431, 432, 433, 434 at a shared entry window 408. As mentioned herein, each electromagnetic signal may comprise multiple entries 410 displayed at multiple shared entry windows, but FIGS. 4-1 and 4-2 are each illustrated with respect to a single entry 410 for each electromagnetic signal for illustrative purpose and ease of discussion. For instance, the electromagnetic signals as shown in FIGS. 4-1 and 4-2 display an entry 410 for the bit of a single index position of an underlying encoding scheme. To elaborate, for the purposes of illustration, each of the electromagnetic signals encode an underlying value having a “1” for a bit of a given index position associated with a shared entry window 408, represented by the display of an entry at that shared entry window 408. Indeed, it will be appreciated that the techniques described with respect to the singular entry 410 of each electromagnetic signal and singular shared entry window 408 can be applied across multiple entries of each electromagnetic signal and the corresponding multiple shared entry windows.

As shown, the shared entry window 408 may be a space, region, or window which is larger than an entry size of the various entries. For example, each entry 410 may have an entry size (e.g., the same or different entry size) that comprises the display of one or more pixels, and the shared entry window 408 may comprise many pixels and/or may be larger than the entry size of the entries 410. The shared entry window 408 may be slightly larger than the entry size or may be considerably larger than the entry size. In this way, an entry 410 may fit, or may be capable of being displayed, within the shared entry window 408 at any of a variety of positions. For example, in some cases an entry may be capable of being displayed at 4, 6, 8, 12, 16, 20, or more different positions within the shared entry window 408.

In some cases, the shared entry window 408 may be larger than the entry size of the entries 410 in a horizontal dimension such that the entries 410 may be positioned at different horizontal locations as shown. In some cases, the shared entry window 408 may be larger than the entry size of the entries 410 in a vertical dimension such that the entries 410 may be positioned at different vertical positions. In some cases, the entry window 408 may be sized such that the entries 410 can be positioned in 2 dimensions, both vertically and horizontally within the shared entry window 408.

In some embodiments, the size (e.g., and shape) of the shared entry window 408 may be determined based on accuracy and bandwidth considerations. For example, accuracy may be increased with a larger shared entry window 408 based on a reduced likelihood of overlap and light saturation of the associated entries as described in more detail below. However, larger shared entry windows may correspond with larger bandwidth usage, for example, as an image sensor has more display space to scan, tally, sum, etc. Accordingly, based on the requirements of a given application, the size of the shared entry window 408 may be determined. In some cases, each of the shared entry windows for each of the index positions may be the same size. In other examples, one or more shared entry windows for one or more index positions may be smaller or larger than various other entry windows for various other index positions. For instance, in some implementations, more important or more significant index positions (e.g., those corresponding with larger or more significant integer bits and having larger multiplication factors) may correspond with larger shared entry windows such that higher accuracy can be achieved at these more significant digits, for example, at the expense of larger bandwidth usage. Similarly, for less significant index positions (e.g., smaller or less significant decimal bits) smaller shared entry windows may be implemented, which may result in better bandwidth at the expense of lower accuracy for these less significant index positions.

An electromagnetic signal may be displayed based on positioning its entry 410 at a location within the shared entry window 408. For example, in some cases one or more entries 410 may be randomly positioned within the shared entry window 408. In some cases, one or more entries 410 may be positioned at a set or assigned position within the shared entry window 408. For example, the entries 410 may be assigned a positioned in order to identify a corresponding sending node, to minimize or optimize overlap, etc. In some cases, each of the entries (e.g., at each of multiple shared entry windows) for a given electromagnetic signal may each be similarly positioned, or positioned at a same position within each respective shared entry window. In some cases, one or more entries for an electromagnetic signal may be differently positioned within their respective shared entry window than other entries for the electromagnetic signal.

In this way, the cumulative electromagnetic signal 440-1 may include a combination of the entries 410 of the participating electromagnetic signals, which may result in some of the entries overlapping (e.g., entirely or partially) and/or some of the entries being discretely located. For example, the entries 410 for the electromagnetic signals 431 and 434 may partially overlap while being discretely located from the entries 410 for electromagnetic signals 432 and 433. Collocated portions of entries may result in the light intensity summing or adding (e.g., a cumulative electromagnetic property) at the collocated portion. For example, as shown, a collocated portion 417 of the entries 410 of the electromagnetic signals 431 and 434 results in a light intensity that is brighter at the collocated portion 417. A similar effect can be seen at a collocated portion 417 for the entries 410 of electromagnetic signals 432 and 433. In some cases, an entry 410 may be entirely collocated or overlapping with another entry 410 such that all of the two entries 410 having a resulting brighter light intensity. In some cases, an entry 410 may be entirely overlapping with two or more other entries 410 which may themselves be only partially overlapping. Indeed, the entries 410 may be positioned within the shared entry window 408 in any position such that any possible combinations and/or collocations (e.g., including partial collocations) of entries may result.

Thus, the cumulative electromagnetic signal 440-1 may include the various underlying entries 410 displayed and positioned at any of a variety of locations within the shared entry window 408. As described below in more detail, the spatial distribution of the entries 410 in this way may facilitate an increased accuracy and/or reliability for determining the count for the shared entry window 408 and for the associated index position by reducing the likelihood of significant overlap or collocation of a large number of entries 410, and accordingly, the saturation of the image sensor. Indeed, while the cumulative electromagnetic signal 440-1 is illustrated with respect to the four electromagnetic signals 431-434, it should be understood that any number of electromagnetic signals may be displayed at the shared entry window 408, for example, for facilitating the summation of a corresponding number of underlying (e.g., decimal) values.

Turning now to FIG. 4-2, in some cases, the electromagnetic signals may be displayed via entries 411 having segments 413 that are not adjacent, connected, and/or continuous. For instance, as shown via electromagnetic signals 435, 436, 437, and 438, each entry 411 may be displayed as a spatially fragmented array of two or more discrete segments 413. As an example, rather than being a continuous or connected section of pixels, each entry 411 may include segments 413 that can be separated (e.g., in some instances they are positioned adjacent) and displayed via separate or non-continuous sets of pixels. For instance, the entries 411 may include 2, 3, 4, 6, 8, 10 or other number of segments 413 spatially distributed throughout the shared entry window 408. Each of the entries 411 for each of the electromagnetic signals for a given shared entry window 408 is typically segmented with the same number of segments 413. For example, each entry 411 displayed at a given shared entry window 408 may comprise 3 (or other number of) segments 413. In some cases, each shared entry window 408 for the various index positions of the encoding scheme may correspond with the same number of segments 413 per entry 411. In some cases, one or more index positions may correspond with a different number of segments 413 per entry 411. In some cases, the spatially fragmented array may resemble a bar code or line pattern, however, the entries 411 may be arranged as any conceivable pattern of spatially fragmented segments 413. In some cases, the entries 411 may be spatially fragmented in the dimension or axis of the shared entry window 408. For instance, in cases where the shared entry window 408 is larger horizontally than the entry size, the entries 411 may be spatially fragmented in the horizontal direction.

In some cases, the spatially fragmented arrays of the various entries 411 each have a different spatial distribution. For example, similar to that described above in connection with FIG. 4-1, in some cases, the positioning of the entries 411 and the spatial distribution of the array of segments 413 may be random. For example, a node, when displaying an electromagnetic signal, may randomly position the various segments 413 for a given entry 411 within the shared entry window 408. In some cases, the positioning of the entry 411 and spatial distribution of the segments 413 may be set or assigned. For example, the assigning of the positioning of the entries 411 may facilitate reducing, minimizing, or otherwise optimizing the overlap or collocation of segments in the cumulative electromagnetic signal 440-2. In other cases, entries 411 having set positions may facilitate identifying a node corresponding to the electromagnetic signal. In various implementations, entries 411 having set positions may facilitate identifying a maximum or minimum of the underlying values encoded by the participating electromagnetic signals. For example, for the various entries 411 of each electromagnetic signal, the entry 411 corresponding with a most significant index position (e.g., the highest index position encoding a “1” for the underlying value), the entry 411 may have one or more segments positioned at a particular location, such as an entry in a further left position, a furthest right, position, or other position. In this way, based on identifying the positioning of one or more entries, it may be possible to identify the relative value between the electromagnetic signals, such as for determining which electromagnetic signal encodes a highest or maximum value, and/or which electromagnetic signal encodes a lowest or minimum value.

The entries 411 segmented in this way may result in the cumulative electromagnetic signal 440-1 having various segments 413 collocated (e.g., this is likely the case, but it is possible that a cumulative electromagnetic signal results in no overlapping of segments 413). For instance, as shown, some segments 413 of one entry 411 may overlap entirely with segments 413 of other entries 411, and some segments 413 may be discreetly located from other segments 413. In some cases, the segments 413 may not partially overlap, but rather, segments may either be entirely overlapping/collocated or else may be entirely discretely positioned. In this way, entries 411 as a whole may be considered to be partially overlapping based on having some (but not all) of their segments 413 collocated. Similar to one or more embodiments described herein, the light intensities of collocated segments may combine to have a cumulative, brighter, light intensity.

Spatially distributing the entries of the electromagnetic signals as described in any of the embodiments herein (e.g., FIGS. 4-1 and/or 4-2) may facilitate determining the count for a given shared entry window and corresponding index position with a higher accuracy. The encoding scheme as shown and described in connection with FIG. 3 can, in some cases, be implemented based on directly or entirely overlaying or collocating the participating electromagnetic signals. However, with such a technique, increasing the number of electromagnetic signals to be summed (e.g., increasing the number of nodes participating in the collective operation) results in the cumulative electromagnetic signal having electromagnetic properties that need to be detected at an increased number of discrete light intensities. For instance, in the example of FIG. 3, three underlying electromagnetic signals are collocated and summed, resulting in the possibility of four discrete light intensities to be detected in the cumulative electromagnetic signal: light intensity property values of 0, 1, 2, and 3. Thus, for n number of electromagnetic signals (e.g., n number of nodes) participating in a collective operation, n+1 discrete light intensities can potentially be detected at the entries/index positions of the resulting cumulative electromagnetic signal.

In some cases, due to light saturation, it may be increasingly more difficult for image sensors to differentiate between discrete light intensities as the number of discrete light intensity values increases. For instance, a practical limit may exist to the number of electromagnetic signals which may be directly overlayed (e.g., entirely collocated) and included in a collective operation as described based on image sensors not being able to reliably discern between light intensity values. For example, an image sensor may struggle to reliable differentiate a light intensity property value of 12 out of 20 versus a light intensity property value of 13 out of 20. Thus, there may be a practical limit to the number of nodes which may participate in a collective operation through the encoding scheme shown and described in connection with FIG. 3. For example, in some cases image sensors may be capable of detecting up to 17 discrete light intensity values (e.g., 16 light intensities plus no (0) light intensity) with a high fidelity or high reliability. In some cases, implementing less discrete light intensity values, such as up 9 (e.g., 8 intensities plus 0) or up to 5 (e.g., 4 intensities plus 0) may increase accuracy and reduce the likelihood of image saturation.

The spatial distribution techniques for the entries as described in connection with FIGS. 4-1 and 4-2 may facilitate implementing a larger number of electromagnetic signals for a collective operation while also reducing the probability of saturation of an associated image sensor. To elaborate, because the entries are not displayed at a single, common location, but rather are displayed across a larger shared entry window, the probability that a large number (e.g., 8 or more, 12, or more, 16 or more, etc.) of entries are ultimately collocated is reduced. For instance, by randomly distributing the entries within the shared entry window, the probability that a collection of entries overpopulates or oversaturates a given location in the shared entry window so as to saturate an image sensor can be reduced. Further, by strategically assigning locations for each entry within the shared entry window, the risk of light saturation can be further reduced. For example, position assignments can be determined and made based on spreading out the entries for participating electromagnetic signals more sparsely throughout the available area in the shared entry window.

Moreover, the techniques described for segmenting individual entries can even further mitigate risk of light saturation. For instance, by distributing the entry across several segments, the probability that any given entry directly or entirely aligns with another entry is further reduced. Additionally, by representing each entry as multiple segments (e.g., multiple identifiable “1” values) the cumulative electromagnetic signal can effectively represent an average (e.g., when the count is determined and divided by the number of segments per entry) which can reduce the effects of a given location in the shared entry window becoming saturated. Accordingly, by spatially distributing the entries in accordance with various embodiments, the encoding and summation techniques as described herein can be leveraged to increase the accuracy of summation operations and data transmission, while also enabling scaling up to include more nodes (e.g., more electromagnetic signals) in a collective operation.

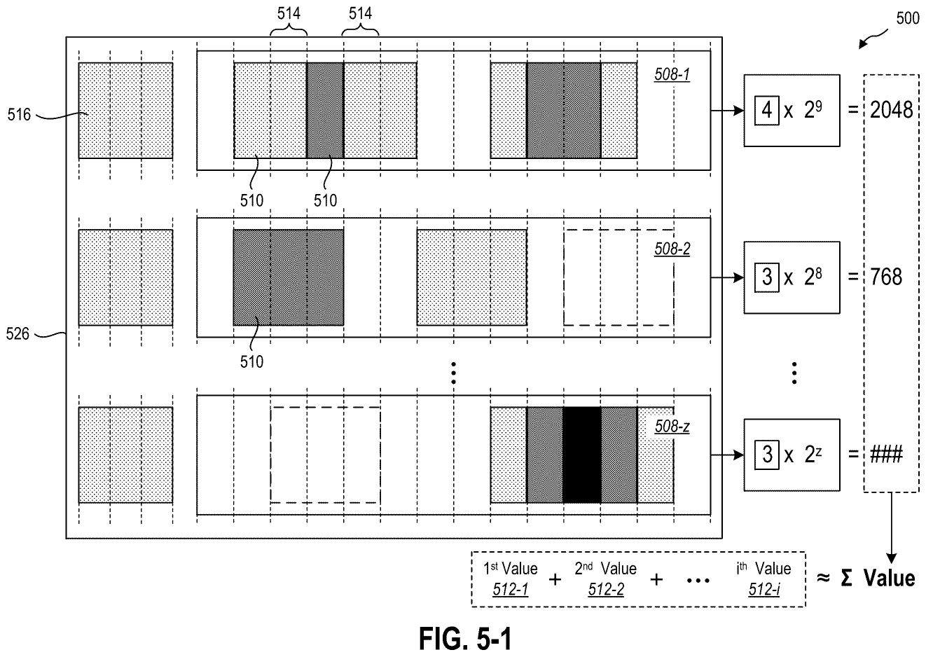

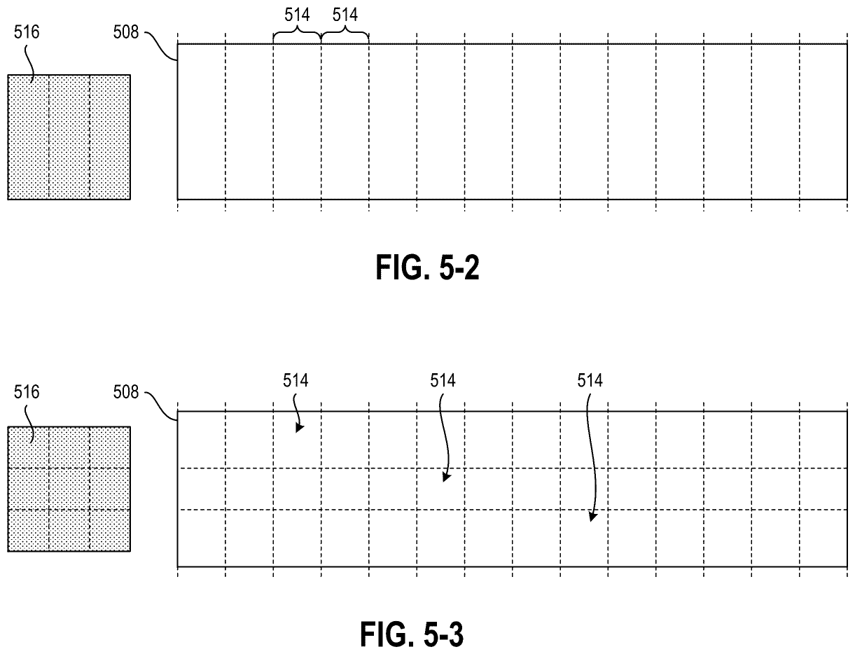

FIG. 5-1 illustrates an example process 500 for determining a sum value 552 by scanning various shared entry windows, according to at least one embodiment of the present disclosure. FIGS. 5-2 and 5-3 illustrate examples of regions of interest within a shared entry window, according to at least one embodiment of the present disclosure. The example process 500 may be in accordance with any of the embodiments and figures as described herein. For example, the example process 500 may be utilized for summing weighted activations for various nodes of a layer of an AI model for transmitting to a node of a next layer.

In the example process 500, a first value 512-1 may be encoded and represented as a first electromagnetic signal having various entries 510 displayed at shared entry windows 508-1 through 508-z (collectively shared entry windows 508), a second value 512-2 may be encoded and represented as a second electromagnetic signal having various entries 510 displayed at the shared entry windows 508, and so on to an ith value 512-i encoded and represented as an ith electromagnetic signal having various entries 510 displayed at the shared entry windows 508 (e.g., collectively values 512). The entries 510 of each of the electromagnetic signals may be encoded via a property of electromagnetic energy to indicate the underlying values 512 as described herein.

In some embodiments, the shared entry windows 508 are displayed on a display 526, which may be one display or multiple displays (e.g., one or more shared entry windows 508 may be displayed at a separate display). In some cases, the electromagnetic signals may all be displayed on the display 526 by the same type of display device such as all being displayed by projector displays or all being displayed by emitter displays. In some cases, one or more of the electromagnetic signals is displayed on the display 526 by a different type of display device, such as one or more electromagnetic signals being displayed on the display 526 by a projector and other electromagnetic signals being displayed on the display 526 by an emitter display device. In this way, the process 500 may be implemented in a wide variety of applications. Indeed, the electromagnetic signals may be displayed in any manner in which entry-wise light intensities of the electromagnetic signals may be observed and detected.

While not shown, an image sensor may view or observe the electromagnetic signals to facilitate summing the underlying values 512. For instance, the image sensor may be configured to isolate, focus on, and/or otherwise observe the various shared entry windows 508, including various regions of interest within the shared entry windows 508. For instance, as shown in FIG. 5-2, a shared entry window 508 may be divided into a plurality of regions of interest 514, for example, in a direction (e.g., horizontal) corresponding with a larger dimension or axis of the shared entry window 508. In cases where the shared entry window 508 is larger in a vertical dimension, the regions of interest 514 may divide the shared entry window 508 in the vertical direction. As shown in FIG. 5-3, in some cases, regions of interest 514 may divide the shared entry window 508 in the vertical and horizontal dimensions. A reference signal 516 may also be divided by regions of interest having the same size, shape, and configuration as the shared entry window 508. For instance, in some cases, the reference signal 516 is displayed next to (or otherwise in relation to) each shared entry window 508, or else one or more reference signals 516 may be otherwise positioned on the display 526.

The regions of interest 514 may represent a configuration or capability for the image sensor to view, detect, or measure at a discrete, isolated portion of a display 526. For example, while the image sensor may be capable of seeing or sensing the entire display 526 (or multiple displays), a region of interest may focus on one discrete portion of the display 526 (e.g., less than all of the display). In various embodiments, the image sensor may be capable of detecting the light intensity at each discrete region of interest 514. In some examples, the regions of interest 514 may correspond to a specific property of electromagnetic energy that the image sensor is configured to detect, such as a color or polarization. In some cases, the entries 510 may be positioned in the shared entry window 508 in alignment with the regions of interest 514, For example each entry 510 may span one, or multiple regions of interest 514 in their entireties. As an example, the edges, ends, or extents of each entry 510 may align with the boundary between adjacent regions of interest 514. In this way, the regions of interest 514 may define and/or align with the potential locations in which an entry 510 may be positioned in the shared entry window 508.

With reference again to FIG. 5-1, the image sensor may leverage the regions of interest 514 to perform summation of the values 512, similar to that described in connection with FIG. 3. For example, the image sensor may scan across the regions of interest 514 for a shared entry window 508, and may count or tally the value of the light intensity at each region of interest for the corresponding index position. For instance, in the example shown, the first shared entry window 508-1 may correspond with a 10^{th} integer index position (or other index position) having a multiplication factor of 2′. When scanning, viewing, detecting, or observing each of the regions of interest 514 in the first entry window 508-1, the image sensor may detect a discrete level (e.g., discrete property value) of light intensity, and may accordingly tally or increase the count by a commensurate number. For regions of interest where the image sensor does not detect any light intensity (e.g., property value of 0) the image sensor may not tally or increase the count.

As an illustrative example, for the first shared entry window 508-1, the image sensor may scan the regions of interest 514, from left to right for example, and may detect or determine the light intensities as 0-1-1-2-1-1-0-0-1-2-2-1-0-0-0. While scanning, the image sensor may accordingly determine an initial count based on increasing the count or tally by the detected value at each region of interest for an initial count of 12. The image sensor may determine the (e.g., final) count based on the reference signal 516. For example, the reference signal 516 may indicate an entry size of each entry with respect to the size of the regions of interest. As shown, the reference signal 516 may span 3 regions of interest 514, similar to that of the entries 510. The image sensor may scan the regions of interest 514 for the reference signal 516 and may determine a reference count for the reference signal, in this case a reference count of 3. By dividing the initial count (12) of the shared entry window 508 by the reference count (3) the count for the index position may be determined as 4, representing that 4 electromagnetic signals are displaying an entry (bit value of 1) for that index position. The multiplication factor 29 can be applied to the count to determine a value for the index position to facilitate determining the sum value 552.

In some cases, the reference signal 516 may facilitate calibrating the image sensor. For example, the reference signal 516 may display a base or reference light intensity, such as a light intensity of 1, which may facilitate the image sensor calibrating the discrete light intensities that it detects. For instance, ambient light, display device settings, observation angle, or other factors may affect the way the image sensor observes or detects images and/or light, and the reference signal 516 may facilitate calibrating the image sensor to accurately detect the light intensity values of the entries 510. Additionally, in cases where the entries are displayed as spatially fragmented arrays of two or more discrete segments, a reference signal may also be displayed for facilitating determining the count. For example, the reference signal may indicate how many segments comprise each entry and how many regions of interest each segment spans. In this way, the reference signal may facilitate determining the count.

The image sensor may proceed in this way scanning through the various shared entry windows 508 until a zth shared entry window 508-z. For example, the initial count for the second shared entry window 508-2 is 9, which when divided by the reference count of 3, results in a count of 3, representing that 3 electromagnetic signals are displaying an entry (bit value of 1) for that index position. The initial count for the zth shared entry window 508-z is also 9, which when divided by the reference count of 3, results in a count of 3, representing that 3 electromagnetic signals are displaying an entry (bit value of 1) for that index position. The phantom entries shown in dotted lines are illustrative of an electromagnetic signal not presenting an entry at a corresponding shared entry window 508, for example, in cases where the encoding for an underlying value 512 results in a bit value of 0 for a given index position. In this way, the image sensor may determine, for each of the index locations of the encoding scheme, a count or tally. The image sensor may utilize the counts and the associated multiplication factors to determine a sum value 552 which may be an approximation, estimate, or calculation of the sum of the first values 512-1, the second value 512-2, and so on to the ith value 512-i.

In some cases, the image sensor may implement a mathematical function in order to account for one or more errors in correctly determining a given light intensity at one or more regions of interest. For example, as mentioned above, in some cases it may be challenging for images sensors to discern between two adjacent or related discrete light intensities, especially when implementing a larger number of discrete light intensities and especially at higher degrees of light saturation. Accordingly, the image sensor may account for errors when determining the count, such as by utilizing ceiling functions or other mathematical or logical operators. To elaborate, while the present techniques may be utilized to reduce the probability that any given position within a shared entry window becomes overly populated or overly saturated, in some cases overpopulation or oversaturation may nevertheless occur at one or more positions despite the lower probability of such occurring. Accordingly, the image sensors may account for such instances in which saturation may occur and in which the exact discrete light intensity may not be determined accurately and/or reliably. For instance, in some cases the image sensor determines the count based on the following formula:

$$Count = ceiling ( \frac{initial count}{reference count} - Noise Factor )$$

In some cases, the ceiling operator determines the smallest integer that is greater than or equal to the operand of the function. Thus, this function may facilitate accounting for instances where the image sensor over counts, or under counts, the initial count based on overcounting and/or undercounting one or more regions of interest.

As an illustrative example, consider the first shared entry window 508-1 in which 4 electromagnetic signals display an entry, which should result in a (e.g., final) count of 4 for the index position as discussed above. Based on a collocated portion 517 the two leftmost entries 510, the cumulative light intensity at the collocated portion may be such that the image sensor makes an error when determining the initial count, such as determining a light intensity value of 1 instead of 2 for the collocated portion 517. Thus, the image sensor may determine an initial count of 11, which when divided by the reference count of 3, results in an incorrect count of 3.66 instead of 4. By applying the ceiling function (ignoring the noise factor which will be described below), the ceiling operator determines the smallest integer that is greater than or equal to 3.66 to be 4, and ultimately the image sensor determines, correctly, a count of 4 for the index position.

The noise factor may be an experimentally determined factor or coefficient which can be subtracted before applying the ceiling operator. For instance, the noise factor may account for variations in ambient light, device settings, image sensor wear, or other factors which may result in the image sensor incorrectly detecting a light intensity that is higher than it should. In some cases, the noise factor may be determined for a specific image sensor, such as based on an observed likelihood and/or extent of which that image sensor typically errs in determine the count. For instance, with reference again to the first shared entry window 508-1, consider the collocated portion 517 of the two leftmost entries 510. In some cases, the image sensor may, incorrectly, determine the light intensity of the collocated portion 517 to be a value of 3 instead of 2, resulting in the image sensor determining an initial count of 13 instead of 12. When divided the initial count, 13, by reference count of 3, the image sensor may determine an incorrect count of 4.33, not 4. By subtracting a noise factor of, for example, 0.5 (or other experimentally determined noise factor), the ceiling operator may be applied to a value of 3.83, and the smallest integer that is greater than or equal to this value is 4. Accordingly, the image sensor determines the correct count, 4, for the index position. Thus, the techniques described herein may be implemented notwithstanding a degree of error in detecting the light intensity of the electromagnetic signals, for example, resulting in the overpopulation or oversaturation of light intensity at a given position of the shared entry window 508.

In this way, the image sensor, based on detection of the light intensity of the entries, collectively, at the shared entry windows 508, may determine the sum total (or an estimate thereof) of the underlying activation values of the electromagnetic signals. While the process 500 may nevertheless involve the image sensor (e.g., in particular an inline processor such as an FPGA) storing and accessing memory resources in order to tally the counts and ultimately determine the sum value 552, this may nevertheless represent a significant savings to the computation and transmission of data between AI layers. For example, tallying a running total of the counts for each index position may require very little memory access, which may pale in comparison to traditional methods of storing and recalling, in mass, each weighted activation and summing of the same. Additionally, the application of the multiplication factors and ultimate summation of the sum value 552, while computations that a processor performs, are few compared to the brute force summation computations of hundreds, thousands, or millions of weighted activations per layer, as are typically performed by processors in traditional AI model solutions. Indeed, because the image sensor (or other processor) is not performing an actual computation on the underlying weighted activations (e.g., summing the underlying values in the typical sense), but rather is only tallying the detecting light intensity at each region of interest, applying a multiplication factor, and summing the results (e.g., summing the values for 16 index positions), the process 500 may realistically be scaled to include any number of electromagnetic signals, or more particularly, the process 500 may facilitate AI models having a considerable number of parameters/neurons at each layer. Indeed, in traditional AI model solutions, there may be a practical limit to the number of nodes that can be processed for each layer, as increasing the number of computations to be performed at each layer may become prohibitively computationally expensive. By spatially distributing the entries as described, an increased number of nodes may be included in the collective operation for summing and consolidating an increased number of weighted activation values to a sum value to transmit to the next layer.

Indeed, the process 500 may also facilitate consolidating the amount of information to be transmitted between layers of an AI model. For instance, because the process 500 determines the sum value 552, this value may be transmitted to a given receiving node of the next layer, and it may not be necessary to communicate any of the underlying weighted activations to that receiving node. In this way, a single sum value may be determined and transmitted to each receiving node, for example, rather than the mass serialization and transmission of all of the weighted activation data for all of the nodes of the sending layer, and the storing of those transmitted weighted activations in memory by the receiving node. The consolidation of data in this way further highlights the efficiency gains that the present techniques provide over bottlenecks that traditional AI systems face.

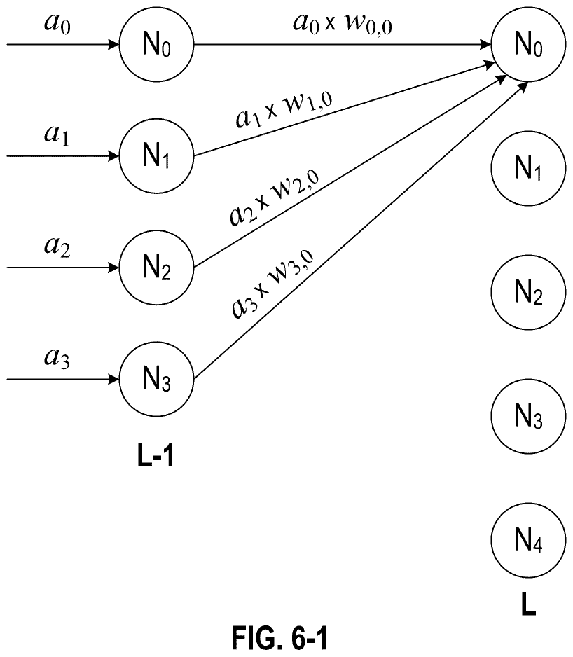

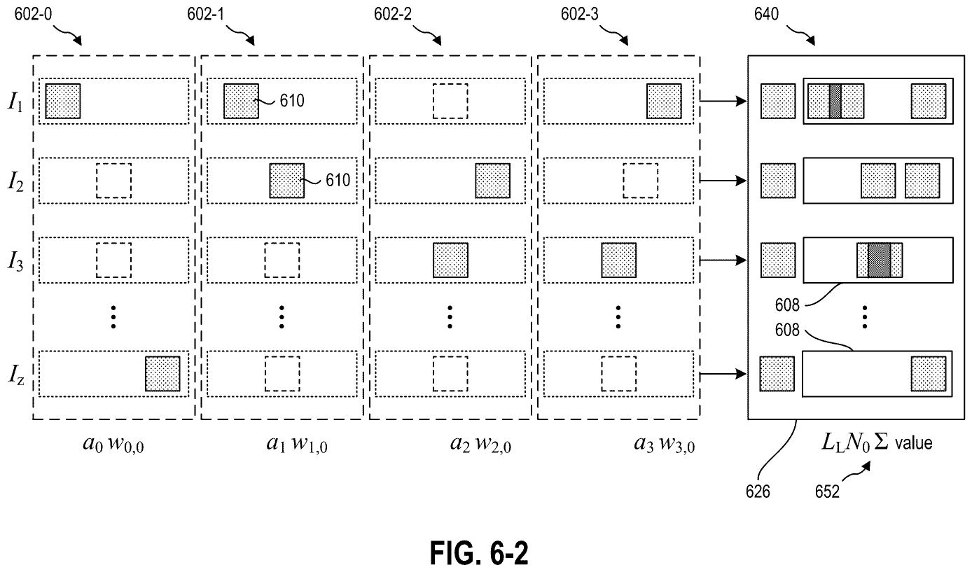

FIG. 6-1 illustrates an example of various nodes N of a layer L−1 and various nodes N of a layer L, and connections therebetween, according to at least one embodiment of the present disclosure. FIG. 6-2 illustrates a cumulative electromagnetic signal representing various weighted activations in relation to the architecture of FIG. 6-1, according to at least one embodiment of the present disclosure.

With reference to FIG. 6-1, in this example, the layer L−1 includes nodes N₀, N₁, N₂, and N₃, and the layer L includes nodes N₀, N₁, N₂, N₃, and N₄. The layers L−1 and L may be layers of an AI model which may include any number, and often many (e.g., thousands, millions, or billions) of nodes, but for simplicity and illustrative purposes, a select few nodes are shown and described.

Each node N of the layer L−1 may receive or may be associated with an activation a, such as based on information received from a previous layer (e.g., layer L−2). In some cases, each activation a may be determined based on an activation function as described herein, including a sum of a collection of several weighted activations, such as a sum of a weighted activation from each node of the previous layer, and a bias applied thereto. The layer L−1 may perform various computations on the activations a as described herein, such as to produce weighted activations for each node N to transmit to the nodes N of the layer L. Typically, the nodes N of each layer are connected to each of the nodes N of the next layer in an all-to-all network configuration. Accordingly, each node N of the layer L−1 is connected to each node N of the layer L. The connections between the node N₀ of layer L and each of the nodes N₀-N₃ of the layer L−1 are shown in FIG. 6-1 for simplicity, but it should be understood that similar connections exist for connecting each of the nodes N of layers L and L−1.

Each of the connections between nodes may correspond to a unique weight w. For example, for a given receiving node, such as node N₀ of layer L−1, the activation (e.g., a₀) may be the same for the node, but depending on the receiving node, the activation may be weighted by a unique weight w corresponding to the receiving node N. For instance, a weight w_{0,0} may correspond to the connection between the node N₀ of the layer L−1 and the node N₀ of the layer L. Further, a weight w_{0,1} may correspond to the connection between the node N₀ of layer L−1 and the node N₁ of layer L, and so on. Accordingly, the activation a of a sending node may be weighted by several different weights w corresponding to the receiving node.

As shown, each of the nodes N₀-N₃ of Layer L−1 is connected to the node N₀ of layer L, and accordingly a weighted activation aw corresponds to the associated connection. For instance, weighted activations a₀w_{0,0}, a₁w_{1,0}, a₂w_{2,0}, and a₃w_{3,0} may correspond with the connections of Nodes N₀-N₃ of Layer L−1 to Node No of layer L. Similar weighted activations in this manner may correspond with the connection of each of the nodes of Layer L−1 to each of the nodes of Layer L.

In this way, each node may correspond with a single activation a, but may compute and transmit many weighted activations equal to the number of nodes in the receiving layer. For instance, the layer L−1 having 4 nodes and the layer L having 5 nodes may result in 20 weighted activations to compute at layer L−1 and transmit to the nodes of layer L. This all-to-all network configuration of the nodes N further highlights the sheer volume of data to be processed at each layer, which can result in bottleneck issues in conventional AI model systems, as discussed herein.

With reference to FIG. 6-2, electromagnetic signals may be utilized in accordance with the techniques described herein for summing weighted activations across multiple nodes, and transmitting a sum value to a receiving node. In this example, four electromagnetic signals 602-0 to 602-3 (collectively 602) may encode the weighted activations a₀w_{0,0}-a₃w_{3,0} respectively. The electromagnetic signals 602 may each be encoded according to the encoding scheme described in connection with FIG. 3, and additionally may be displayed in accordance with any of the techniques for spatial distribution of entries as shown and described in connection with FIGS. 4-1 and 5-3. For instance, the electromagnetic signal 602 may include various entries 610 positioned at corresponding shared entry windows 608 for various index positions I₁-I_{z} of an encoding scheme.

When displayed at the shared entry windows 608 of a display 626, the electromagnetic signals 602 generate the cumulative electromagnetic signal 640. When decoded as described in connection with FIGS. 5-1 through 5-3, the cumulative electromagnetic signal 640 may indicate a sum value 652, which may be a sum of the weighted activations a₀w_{0,0}-a₃w_{3,0}. In this way, the cumulative electromagnetic signal may facilitate determining a sum of the weighted activations destined for a common receiving node (e.g., Node No of Layer L), and may determine the sum value 652 for transmitting to the receiving node, for example, in lieu of transmitting each of the weighted activations a₀w_{0,0}-a₃w_{3,0} to the receiving node for summing by the receiving node.

FIGS. 7-1 through 7-4 illustrate an example of a system 700 performing a collective operation using electromagnetic signals, according to at least one embodiment of the present disclosure. A Layer L−1 is shown, which may include various (and often many) nodes as described herein. The layer L−1 and the corresponding nodes may be hosted, operated, or processed by a processing unit 720 and/or associated memory 722 (or multiple processing units and multiple memories). The processing unit 720 and memory 722 may be any of the processing units and memories as described herein, such as a GPU and VRAM.

Each node of Layer L−1 may generate (e.g., via the processing unit 720) various electromagnetic signals for displaying on one or more displays as described herein. Each electromagnetic signal may encode weighted activations associated with connections of the nodes of Layer L−1 to nodes of a Layer L. Additionally, each node of Layer L−1 (e.g., via the processing unit 720) may display its various electromagnetic signals at sets of shared entry windows 708 for generating cumulative electromagnetic signals (collectively 740) and for performing summation of a set of weighted activations that correspond with a common receiving node. For instance, a cumulative electromagnetic signal 740-0 may correspond with a node N₀ of layer L, a cumulative electromagnetic signal 740-1 may correspond with a node N₁ of layer L, a cumulative electromagnetic signal 740-2 may correspond with a node N₂ of layer L, a cumulative electromagnetic signal 740-3 may correspond with a node N₃ of layer L, and a cumulative electromagnetic signal 740-4 may correspond with a node N₄ of layer L. Accordingly, each node of the layer L−1 may display its electromagnetic signal (e.g., its weighted activation) corresponding to the connection of that node with node N₀ of layer L to generate the cumulative electromagnetic signal 740-0, each node of the layer L−1 may display its electromagnetic signal corresponding to the connection of that node with the node N₁ of layer L to generate the cumulative electromagnetic signal 740-1, and so on. In this way, each of the cumulative electromagnetic signals 740 may comprise a set of electromagnetic signals corresponding to the set of weighted activations to be summed for a common receiving node.

The system 700 includes an image sensor 734, which may include or may be associated with a processing unit 730 and memory 732, for example, in line with the image sensor 734. In this example, the image sensor 734 may be configured to view and/or observe each of the cumulative electromagnetic signals 740. For instance, the cumulative electromagnetic signals 740 may be displayed on one or more displays. The displays may be positioned near or adjacent one another, or may be otherwise located, such as at discrete locations of a room or space. The image sensor 734 may view one or more of the displays based on a field of view of the image sensor 734 and/or the image sensor 734 may be configured with a gimbal or other mechanism for adjusting the field of view.

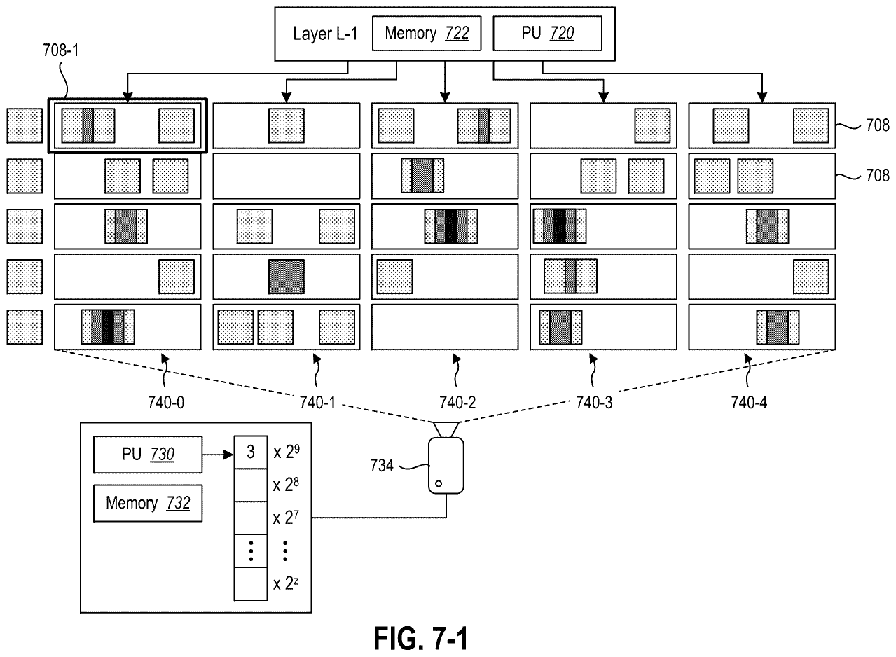

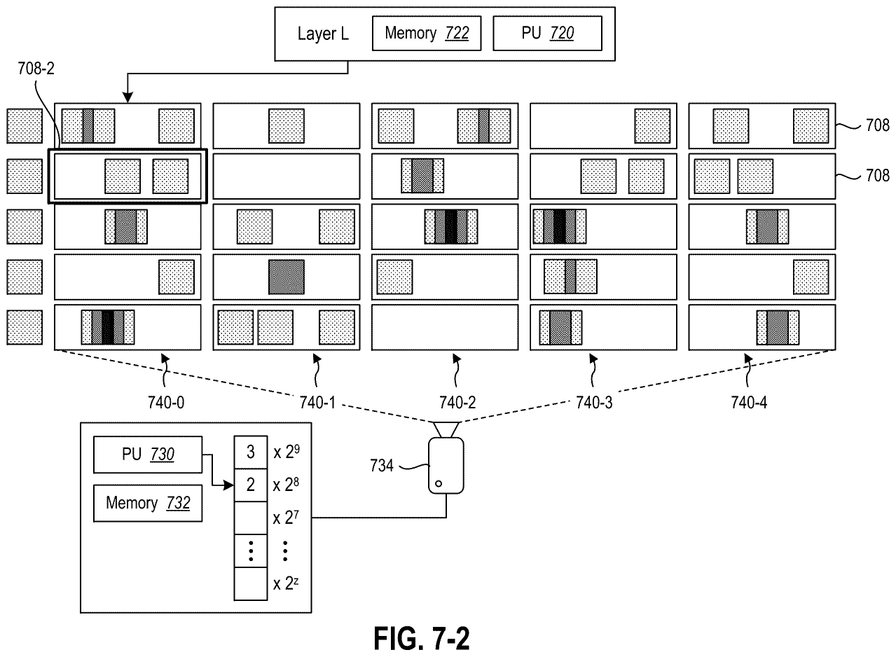

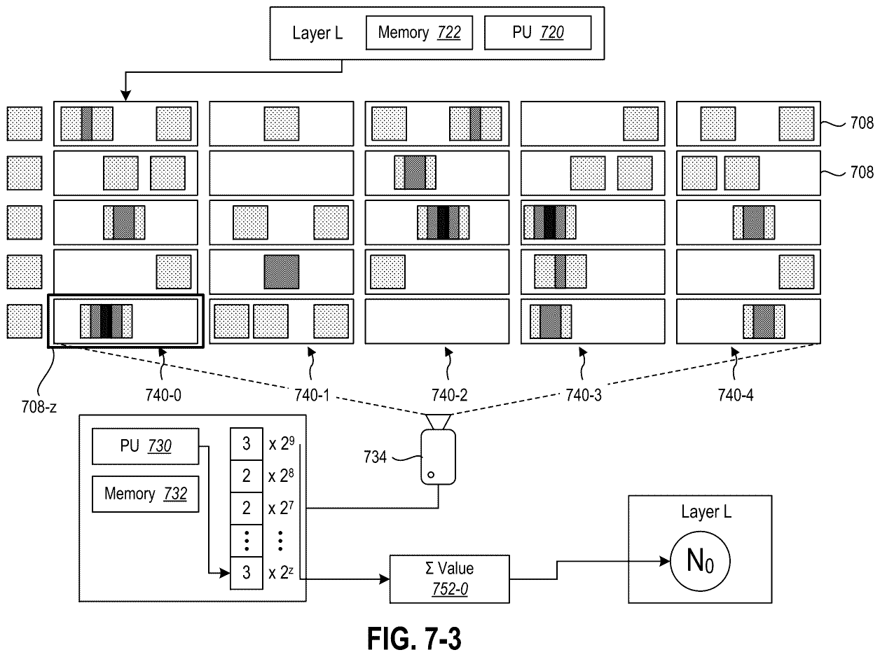

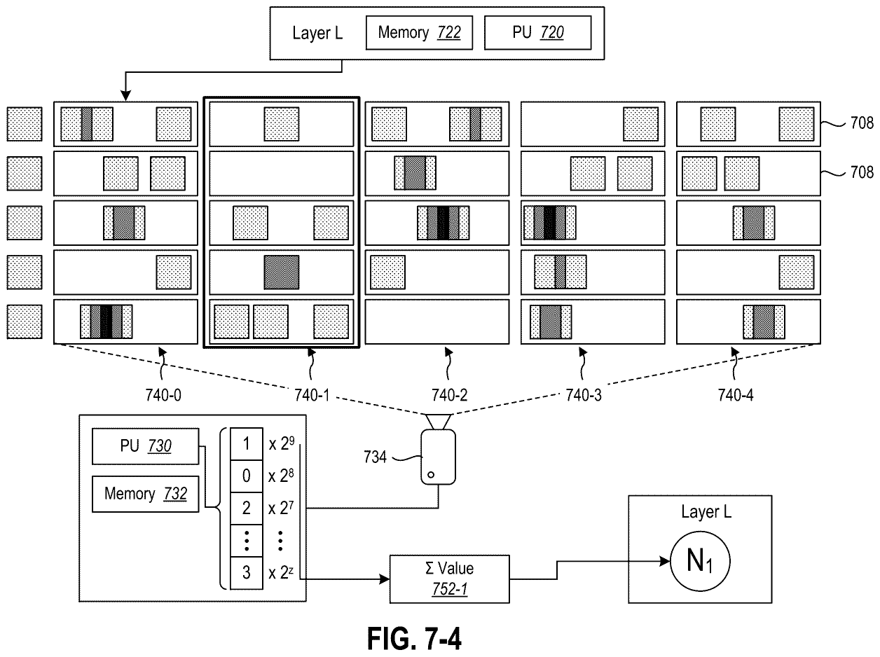

The image sensor 734 may observe the cumulative electromagnetic signals 740 for summing the weighted activations encoded therein, similar to one or more embodiments described herein. For example, the image sensor 734 may be configured to focus on, detect, observe, and/or measure at the various shared entry windows 708. Additionally, as described in connection with FIGS. 5-1 to 5-3, the image sensor 734 may be configured to observe or detect at various regions of interest within each shared entry window 708 in order to determine light intensities at the regions of interest in accordance with one or more embodiments as described herein. The shared entry windows 708 may correspond with a specific index position of an encoding scheme by which the underlying electromagnetic signals are encoded. The image sensor 734 may scan through (e.g., view each of in turn) a set of regions of interest which may all be associated and may determine a count or tally for a corresponding shared entry window 708. For instance, in this example of FIG. 7-1, the image sensor 734 observes a first shared entry window 708-1 and determines the count to be 3, indicating that, of the underlying electromagnetic signals comprising the cumulative electromagnetic signals 740-0, 3 electromagnetic signals are presenting entries for an associated index position. Thus, the image sensor 734 may determine that for the associated index position (e.g., a tenth integer index position) the count is 3. As shown, this index position may correspond with a multiplication factor of 2′.

After determining the count for the index position, the image sensor 734 may proceed to a next shared entry window 708. As shown in FIG. 7-2, a second shared entry window 708-2 may correspond with next entries in the cumulative electromagnetic signal 740-0. The image sensor 734 may scan through each of the regions of interest of this shared entry window and may determine the count of the associated entries to be 2, indicating that two underlying electromagnetic signals are presenting entries for the associated index position. Accordingly, the image sensor 734 may populate the count of 2 for the associated index position, which may correspond with a multiplication factor of 2⁸.

As shown in FIG. 7-3, the image sensor 734 may continue in this manner through the various shared entry windows 708 until a shared entry window 708-z. The image sensor 734 may in this way determine each (all in some embodiments) of the counts of the index positions. For instance, in some cases the encoding scheme includes 16 index positions, or any other quantity of index positions may be utilized in connection with any other encoding scheme. The image sensor 734 may then apply the associated multiplication factors and sum the results to generate a sum value 752-0. For instance, the sum value 752-0 may be a sum of the weighted activations from each of the nodes of Layer L−1 as connected to the node NO of layer L. The image sensor 734 may then transmit the sum value 752-0 to the layer L (e.g., to the node NO of layer L). In this way, the system 700 may facilitate collecting and summing each of the relevant weighted activations for node NO of layer L, and transmitting just the sum value 752-0 to the layer L. For instance, the collective operation (e.g., sum) in this case may be performed without transmitting the underlying weighted activations to the layer L. Additionally, the collective operation may be performed without a processor having actually performed a conventional sum computation on each of the weighted activations, but rather, the sum value 752-0 may be determined (e.g., estimated) based on tallying or counting the light intensities as the shared entry windows 708 as described.

As shown in FIG. 7-4, the image sensor 734 may proceed in a similar manner with respect to a next cumulative electromagnetic signal, such as the cumulative electromagnetic signal 740-1. For example, the image sensor 734 may proceed to scan through the shared entry windows 708 (e.g., and the corresponding regions of interest at each shared entry window 708) for the cumulative electromagnetic signal 740-1, which may represent or communicate each of the weighted activations for each of the nodes of the layer L−1 in connection with a node N₁ of the layer L. Based on determining a count for each index location, applying the multiplication factors, and summing the results, the image sensor 734 may determine a sum value 752-1, which may be a sum of all the weighted activations as applicable to the node N₁ of the layer L. Accordingly, the image sensor 734 may transmit the sum value 752-1 to the layer L (e.g., to the node N₁). In this way, the image sensor 734 may proceed through each of the cumulative electromagnetic signals 740 in order to determine sums of each of the sets of weighted activations that apply to a given receiving node of the layer L. For instance, in this example, the layer L includes 5 nodes N, and the image sensor 734 may accordingly determine 5 distinct sum values for transmitting to the corresponding 5 nodes of the layer L (e.g., one to each receiving node) As a simple example then, consider a total of 4 nodes in the layer L−1 each having a distinct weighted activation associated with each of the 5 nodes of the layer L, totaling 20 activations. These 20 activations may be consolidated to 5 sum values for transmitting to the layer L, highlighting the efficiency gains by the system 700. Indeed, when considered at the scale of thousands to millions of nodes per layer, the consolidation of data to be transmitted in this way is significant and may facilitate reducing the latency associated with AI model operation.

In some cases, one or more of the image sensors as described herein (e.g., in any of the embodiments) may be representative of a feed or image as generated from two or more image sensors, but which has been stitched or aggregated to produce a composite image for evaluating regions of interest by a (e.g., single) processing unit. In this way, large displays or large areas of multiple displays may be utilized to display a considerable number of cumulative electromagnetic signals, which may be viewed by multiple image sensors and stitched together for analyzing via the various regions of interest as described herein.

In some cases (in any of the embodiments described herein), when transmitting a sum value from a processing unit (e.g., processing unit of an image sensor) to a next layer or receiving node, the sum value may be transmitted electronically. For example, the sum value may be transmitted via hardwired connection, wireless connection, fiber optic connection, or other connection. In some cases, the sum value may be transmitted through the use of electromagnetic signals as described herein. For example, the decimal number of the sum value may be encoded into an electromagnetic signal using one or more of the encoding techniques as described herein, one or more other encoding techniques, or combinations thereof. The receiving layer or receiving node may be equipped with an image sensor for detecting and/or measuring the encoded electromagnetic signal and in this way may receive the sum value.

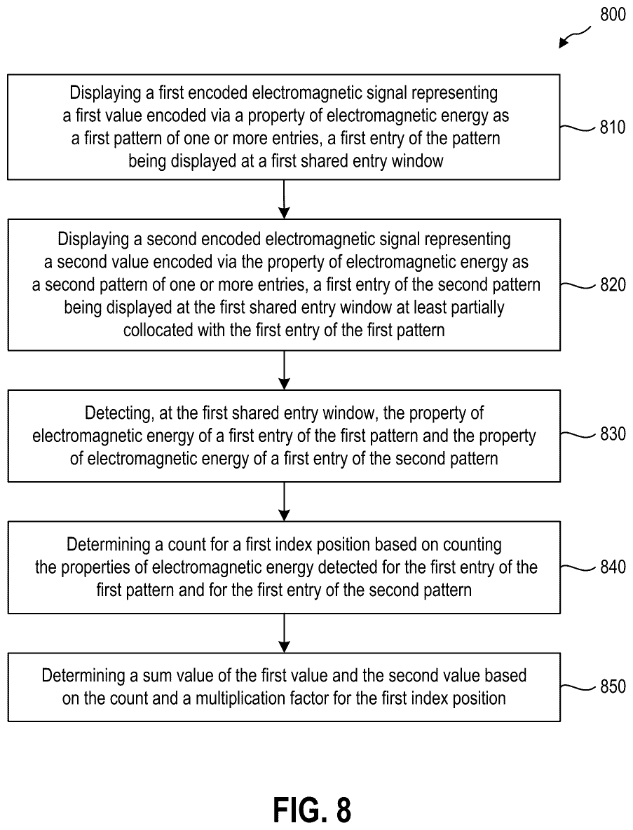

FIG. 8 illustrates a flow diagram for a method 800 or a series of acts for performing a collective operation using electromagnetic energy, according to at least one embodiment of the present disclosure. While FIG. 8 illustrates acts according to one embodiment, alternative embodiments may add to, omit, reorder, or modify any of the acts of FIG. 8.

In some embodiments, the method 800 includes an act 810 of displaying a first encoded electromagnetic signal representing a first value encoded via a property of electromagnetic energy as a first pattern of one or more entries, a first entry of the first pattern being displayed at a first shared entry window.

In some embodiments, the method 800 includes an act 820 of displaying a second encoded electromagnetic signal representing a second value encoded via the property of electromagnetic energy as a second pattern of one or more entries, a first entry of the second pattern being displayed at the first shared entry window at least partially collocated with the first entry of the first pattern.

In some embodiments, the method 800 includes an act 830 of detecting, at the first shared entry window, the property of electromagnetic energy of the first entry of the first pattern and the property of electromagnetic energy of the first entry of the second pattern.

In some embodiments, the method 800 includes an act 840 of determining a count for a first index position based on counting the properties of electromagnetic energy detected for the first entry of the first pattern and for the first entry of the second pattern.

In some embodiments, the method 800 includes an act 850 of determining a sum value of the first value and the second value based on the count and a multiplication factor for the first index position.

In some embodiments, the first shared entry window is larger than an entry size of the first entry of the first pattern and an entry size of the first entry of the second pattern. In some embodiments, the first entry of the first pattern and the first entry of the second pattern have a same entry size. In some embodiments, detecting includes detecting, at a set of regions of interest defined throughout the first shared entry window, the property of electromagnetic energy of the first entry of the first pattern and the property of electromagnetic energy of the first entry of the second pattern. In some embodiments, an entry size of the first entry of the first pattern and an entry size of the first entry of the second pattern each span multiple regions of interest of the set of regions of interest.

In some embodiments, determining the count includes counting at least a cumulative property of electromagnetic energy for a collocated portion of the first entry of the first pattern that is collocated with a collocated portion of the first entry of the second pattern. In some embodiments, the cumulative property is based on a combination of the property of electromagnetic energy of the collocated portion of the first entry of the first pattern and the property of electromagnetic energy of the collocated portion of the first entry of the second pattern.

In some embodiments, the method 800 further includes displaying a reference electromagnetic signal positioned with respect to the first shared entry window, and determining the count includes detecting a property value of the property of electromagnetic energy of the reference electromagnetic signal. In some embodiments, the property of electromagnetic energy is a light intensity of a wavelength of electromagnetic energy.

In some embodiments, the first index position corresponds with an index position of the first entry of the first pattern and of the first entry of the second pattern. In some embodiments, the multiplication factor is a binary exponential multiplication factor. In some embodiments, the first encoded electromagnetic signal and the second encoded electromagnetic signal each encode patterns as fixed-point binary bit patterns having a fixed number of integer bits and a fixed number of fractional bits.

In some embodiments, the method 800 further includes determining the sum value without performing a sum computation with a processing unit on the first value and the second value. In some embodiments, the method 800 further includes determining the sum value without transmitting the first and second values from one or more processing units to a receiving processing unit to perform a sum computation on the first and second values with the receiving processing unit.

In some embodiments, displaying the first encoded electromagnetic signal includes randomly positioning the first entry of the first pattern within the first shared entry window and displaying the second encoded electromagnetic signal includes randomly positioning the first entry of the second pattern within the first shared entry window. In some embodiments, the first entry of the first pattern is displayed as a first spatially fragmented array of a two or more discrete segments, and the first entry of the second pattern is displayed as a second spatially fragmented array of two or more discrete segments, wherein the two or more discrete segments of first spatially fragmented array have a different spatial distribution than the two or more discrete segments of the second spatially fragmented array. In some embodiments, the first entry of the first pattern is displayed at the first shared entry window at least partially collocated with the first entry of the second pattern based on at least one of the two or more discrete segments of the first spatially fragmented array being collocated with at least one of the two or more discrete segments of the second spatially fragmented array.

In some embodiments, the method 800 includes, for each node of a plurality of nodes of a layer of an artificial intelligence (AI) model, determining a weighted input for the node, generating an encoded electromagnetic signal representing the weighted input via a property of electromagnetic energy as a pattern of a set of entries, and displaying the encoded electromagnetic signal on one or more displays including displaying each entry at a corresponding shared entry window of a plurality of shared entry windows, detecting, at the plurality of shared entry windows, the property of electromagnetic energy of each entry of the encoded electromagnetic signals for the plurality of nodes, wherein each shared entry window corresponds to an index position of the patterns of each of the electromagnetic signals, and wherein for at least one shared entry window of the plurality of shared entry windows, two or more entries for two or more patterns of corresponding encoded electromagnetic signals are at least partially collocated, determining, for at least one index position, a count based on counting the properties of electromagnetic energy detected at a shared entry window of the plurality of shared entry windows associated with the at least one index position, determining a sum value of the values represented by the encoded electromagnetic signals for the plurality of nodes based on the count and a multiplication factor for the at least one index position, and communicating the sum value to a receiving node of a receiving layer of the AI model

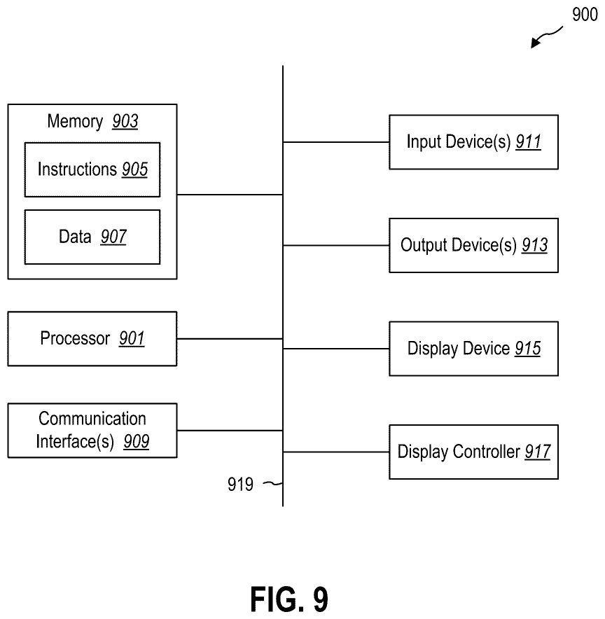

Turning now to FIG. 9, this figure illustrates certain components that may be included within a computer system 900. One or more computer systems 900 may be used to implement the various devices, components, and systems described herein.

The computer system 900 includes a processor 901. The processor 901 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 909 may connect the computer system 900 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into one or more of text, graphics, or moving images (as appropriate) shown on the display device 915.

The various components of the computer system 900 may be coupled together by one or more buses, which may include one or more of a power bus, a control signal bus, a status signal bus, a data bus, other similar components, or combinations thereof. For the sake of clarity, the various buses are illustrated in FIG. 9 as a bus system 919.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ [0124]-[0146] includes various embodiments that, where feasible, may be combined in any permutation. For example, the embodiment of paragraph [0124] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method of performing a collective operation using electromagnetic energy includes displaying a first encoded electromagnetic signal representing a first value encoded via a property of electromagnetic energy as a first pattern of one or more entries, a first entry of the first pattern being displayed at a first shared entry window, displaying a second encoded electromagnetic signal representing a second value encoded via the property of electromagnetic energy as a second pattern of one or more entries, a first entry of the second pattern being displayed at the first shared entry window at least partially collocated with the first entry of the first pattern, detecting, at the first shared entry window, the property of electromagnetic energy of the first entry of the first pattern and the property of electromagnetic energy of the first entry of the second pattern, determining a count for a first index position based on counting the properties of electromagnetic energy detected for the first entry of the first pattern and for the first entry of the second pattern, and determining a sum value of the first value and the second value based on the count and a multiplication factor for the first index position.

In some embodiments, the first shared entry window is larger than an entry size of the first entry of the first pattern and an entry size of the first entry of the second pattern.

In some embodiments, the first entry of the first pattern and the first entry of the second pattern have a same entry size.

In some embodiments, determining the count includes counting at least a cumulative property of electromagnetic energy for a collocated portion of the first entry of the first pattern that is collocated with a collocated portion of the first entry of the second pattern.

In some embodiments, the cumulative property is based on a combination of the property of electromagnetic energy of the collocated portion of the first entry of the first pattern and the property of electromagnetic energy of the collocated portion of the first entry of the second pattern.

In some embodiments, detecting includes detecting, at a set of regions of interest defined throughout the first shared entry window, the property of electromagnetic energy of the first entry of the first pattern and the property of electromagnetic energy of the first entry of the second pattern.

In some embodiments, an entry size of the first entry of the first pattern and an entry size of the first entry of the second pattern each span multiple regions of interest of the set of regions of interest.

In some embodiments, the method further includes displaying a reference electromagnetic signal positioned with respect to the first shared entry window, and determining the count includes detecting a property value of the property of electromagnetic energy of the reference electromagnetic signal.

In some embodiments, the property of electromagnetic energy is a light intensity of a wavelength of electromagnetic energy.

In some embodiments, the first index position corresponds with an index position of the first entry of the first pattern and of the first entry of the second pattern.

In some embodiments, the multiplication factor is a binary exponential multiplication factor.

In some embodiments, the first encoded electromagnetic signal and the second encoded electromagnetic signal each encode patterns as fixed-point binary bit patterns having a fixed number of integer bits and a fixed number of fractional bits.

In some embodiments, the method further includes determining the sum value without performing a sum computation with a processing unit on the first value and the second value.

In some embodiments, the method further includes determining the sum value without transmitting the first and second values from one or more processing units to a receiving processing unit to perform a sum computation on the first and second values with the receiving processing unit.

In some embodiments, displaying the first encoded electromagnetic signal includes randomly positioning the first entry of the first pattern within the first shared entry window and displaying the second encoded electromagnetic signal includes randomly positioning the first entry of the second pattern within the first shared entry window.

In some embodiments, the first entry of the first pattern is displayed as a first spatially fragmented array of a two or more discrete segments, and the first entry of the second pattern is displayed as a second spatially fragmented array of two or more discrete segments, wherein the two or more discrete segments of first spatially fragmented array have a different spatial distribution than the two or more discrete segments of the second spatially fragmented array.

In some embodiments, the first entry of the first pattern is displayed at the first shared entry window at least partially collocated with the first entry of the second pattern based on at least one of the two or more discrete segments of the first spatially fragmented array being collocated with at least one of the two or more discrete segments of the second spatially fragmented array.

In some embodiments, a system includes a display device, an image sensor, one or more processing units, memory in electronic communication with the one or more processing units, and instructions stored in the memory, the instructions being executable by the one or more processing units to, with the display device, display a first encoded electromagnetic signal representing a first value encoded via a property of electromagnetic energy as a first pattern of one or more entries, a first entry of the first pattern being displayed at a first shared entry window, and display a second encoded electromagnetic signal representing a second value encoded via the property of electromagnetic energy as a second pattern of one or more entries, a first entry of the second pattern being displayed at the first shared entry window at least partially collocated with the first entry of the first pattern, with the image sensor, detect, at the first shared entry window, the property of electromagnetic energy of the first entry of the first pattern and the property of electromagnetic energy of the first entry of the second pattern, with the one or more processing units, determine a count for a first index position based on counting the properties of electromagnetic energy detected for the first entry of the first pattern and for the first entry of the second pattern, and determine a sum value of the first value and the second value based on the count and a multiplication factor for the first index position.

In some embodiments, the display device includes a first projector and a second projector, and further comprising, with the first projector, projecting the first encoded electromagnetic signal including projecting the first entry of the first pattern onto the first shared entry window, and with the second projector, projecting the second encoded electromagnetic signal including projecting the first entry of the second pattern onto the first shared entry window at least partially overlapping the first entry of the first pattern.

In some embodiments, the display device includes an emitter display device having a first set of emitters that is collocated with a second set of emitters, and further comprising, with the first set of emitters, displaying the first encoded electromagnetic signal including displaying the first entry of the first pattern at the first shared entry window, and with the second set of emitters, displaying the second encoded electromagnetic signal including displaying the first entry of the second pattern at the first shared entry window at least partially collocated with the first entry of the first pattern.

In some embodiments, the image sensor is one or more of a camera, a photodetector, or a light sensor.

In some embodiments, a method of performing a collective operation using electromagnetic energy includes, for each node of a plurality of nodes of a layer of an artificial intelligence (AI) model, determining a weighted input for the node, generating an encoded electromagnetic signal representing the weighted input via a property of electromagnetic energy as a pattern of a set of entries, and displaying the encoded electromagnetic signal on one or more displays including displaying each entry at a corresponding shared entry window of a plurality of shared entry windows, detecting, at the plurality of shared entry windows, the property of electromagnetic energy of each entry of the encoded electromagnetic signals for the plurality of nodes, wherein each shared entry window corresponds to an index position of the patterns of each of the electromagnetic signals, and wherein for at least one shared entry window of the plurality of shared entry windows, two or more entries for two or more patterns of corresponding encoded electromagnetic signals are at least partially collocated, determining, for at least one index position, a count based on counting the properties of electromagnetic energy detected at a shared entry window of the plurality of shared entry windows associated with the at least one index position, determining a sum value of the values represented by the encoded electromagnetic signals for the plurality of nodes based on the count and a multiplication factor for the at least one index position, and communicating the sum value to a receiving node of a receiving layer of the AI model.

In some embodiments, the method further includes communicating the sum value to the receiving node without communicating the weighted inputs for the plurality of nodes to the receiving node.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 10% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any or all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of performing a collective operation using electromagnetic energy, comprising:
displaying a first encoded electromagnetic signal representing a first value encoded via a property of electromagnetic energy as a first pattern of one or more entries, a first entry of the first pattern being displayed at a first shared entry window;
displaying a second encoded electromagnetic signal representing a second value encoded via the property of electromagnetic energy as a second pattern of one or more entries, a first entry of the second pattern being displayed at the first shared entry window at least partially collocated with the first entry of the first pattern;
detecting, at the first shared entry window, the property of electromagnetic energy of the first entry of the first pattern and the property of electromagnetic energy of the first entry of the second pattern;
determining a count for a first index position based on counting the properties of electromagnetic energy detected for the first entry of the first pattern and for the first entry of the second pattern; and
determining a sum value of the first value and the second value based on the count and a multiplication factor for the first index position.

2. The method of claim 1, wherein the first shared entry window is larger than an entry size of the first entry of the first pattern and an entry size of the first entry of the second pattern.

3. The method of claim 1, wherein determining the count includes counting at least a cumulative property of electromagnetic energy for a collocated portion of the first entry of the first pattern that is collocated with a collocated portion of the first entry of the second pattern.

4. The method of claim 1, wherein detecting includes detecting, at a set of regions of interest defined throughout the first shared entry window, the property of electromagnetic energy of the first entry of the first pattern and the property of electromagnetic energy of the first entry of the second pattern.

5. The method of claim 4, wherein an entry size of the first entry of the first pattern and an entry size of the first entry of the second pattern each span multiple regions of interest of the set of regions of interest.

6. The method of claim 4, further comprising displaying a reference electromagnetic signal positioned with respect to the first shared entry window, and determining the count includes detecting a property value of the property of electromagnetic energy of the reference electromagnetic signal.

7. The method of claim 1, wherein the property of electromagnetic energy is a light intensity or a wavelength of electromagnetic energy.

8. The method of claim 1, wherein the multiplication factor is a binary exponential multiplication factor.

9. The method of claim 1, wherein the first encoded electromagnetic signal and the second encoded electromagnetic signal each encode patterns as fixed-point binary bit patterns having a fixed number of integer bits and a fixed number of fractional bits, and wherein the first index position corresponds with an index position of the fixed-point binary pattern of the first entry of the first pattern and of the first entry of the second pattern.

10. The method of claim 1, further comprising determining the sum value without performing a sum computation with a processing unit on the first value and the second value.

11. The method of claim 1, further comprising determining the sum value without transmitting the first and second values from one or more processing units to a receiving processing unit to perform a sum computation on the first and second values with the receiving processing unit.

12. The method of claim 1, wherein displaying the first encoded electromagnetic signal includes randomly positioning the first entry of the first pattern within the first shared entry window and displaying the second encoded electromagnetic signal includes randomly positioning the first entry of the second pattern within the first shared entry window.

13. The method of claim 1, wherein the first entry of the first pattern is displayed as a first spatially fragmented array of a two or more discrete segments, and the first entry of the second pattern is displayed as a second spatially fragmented array of two or more discrete segments, wherein the two or more discrete segments of first spatially fragmented array have a different spatial distribution than the two or more discrete segments of the second spatially fragmented array.

14. The method of claim 13, wherein the first entry of the first pattern is displayed at the first shared entry window at least partially collocated with the first entry of the second pattern based on at least one of the two or more discrete segments of the first spatially fragmented array being collocated with at least one of the two or more discrete segments of the second spatially fragmented array.

15. A system, comprising:
a display device;
an image sensor;
one or more processing units;
memory in electronic communication with the one or more processing units; and
instructions stored in the memory, the instructions being executable by the one or more processing units to:
with the display device:
display a first encoded electromagnetic signal representing a first value encoded via a property of electromagnetic energy as a first pattern of one or more entries, a first entry of the first pattern being displayed at a first shared entry window; and
display a second encoded electromagnetic signal representing a second value encoded via the property of electromagnetic energy as a second pattern of one or more entries, a first entry of the second pattern being displayed at the first shared entry window at least partially collocated with the first entry of the first pattern;
with the image sensor, detect, at the first shared entry window, the property of electromagnetic energy of the first entry of the first pattern and the property of electromagnetic energy of the first entry of the second pattern; and
with the one or more processing units:
determine a count for a first index position based on counting the properties of electromagnetic energy detected for the first entry of the first pattern and for the first entry of the second pattern; and
determine a sum value of the first value and the second value based on the count and a multiplication factor for the first index position.

16. The system of claim 15, wherein the display device includes a first projector and a second projector, and further comprising:
with the first projector, projecting the first encoded electromagnetic signal including projecting the first entry of the first pattern onto the first shared entry window; and
with the second projector, projecting the second encoded electromagnetic signal including projecting the first entry of the second pattern onto the first shared entry window at least partially overlapping the first entry of the first pattern.

17. The system of claim 15, wherein the display device includes an emitter display device having a first set of emitters that is collocated with a second set of emitters, and further comprising:
with the first set of emitters, displaying the first encoded electromagnetic signal including displaying the first entry of the first pattern at the first shared entry window; and
with the second set of emitters, displaying the second encoded electromagnetic signal including displaying the first entry of the second pattern at the first shared entry window at least partially collocated with the first entry of the first pattern.

18. The system of claim 15, wherein the image sensor is one or more of a camera, a photodetector, or a light sensor.

19. A method of performing a collective operation using electromagnetic energy, comprising:
for each node of a plurality of nodes of a layer of an artificial intelligence (AI) model:
determining a weighted input for the node;
generating an encoded electromagnetic signal representing the weighted input via a property of electromagnetic energy as a pattern of a set of entries; and
displaying the encoded electromagnetic signal on one or more displays including displaying each entry at a corresponding shared entry window of a plurality of shared entry windows;
detecting, at the plurality of shared entry windows, the property of electromagnetic energy of each entry of the encoded electromagnetic signals for the plurality of nodes, wherein each shared entry window corresponds to an index position of the patterns of each of the electromagnetic signals, and wherein for at least one shared entry window of the plurality of shared entry windows, two or more entries for two or more patterns of corresponding encoded electromagnetic signals are at least partially collocated;
determining, for at least one index position, a count based on counting the properties of electromagnetic energy detected at a shared entry window of the plurality of shared entry windows associated with the at least one index position;
determining a sum value of the values represented by the encoded electromagnetic signals for the plurality of nodes based on the count and a multiplication factor for the at least one index position; and
communicating the sum value to a receiving node of a receiving layer of the AI model.

20. The method of claim 19, further comprising communicating the sum value to the receiving node without communicating the weighted inputs for the plurality of nodes to the receiving node.
